(19) United States
(12) Patent Application Publication
(10) Pub. No.: US 2026/0239313 A1
(43) Pub. Date: Aug. 13, 2026

(54) BEACON SIGNAL TRANSMISSION AND RECEPTION TECHNIQUE

(71) Applicant: Telefonaktiebolaget LM Ericsson (publ), Stockholm (SE)

(72) Inventors: Magnus Åström, Lund (SE); Peter Alriksson, Lund (SE); Ratheesh Kumar Mungara, Stockholm (SE)

(21) Appl. No.: 19/532,601

(22) Filed: Feb. 6, 2026

Related U.S. Application Data
(60) Provisional application No. 63/755,915, filed on Feb. 7, 2025.

(51) Int. Cl. H04W 72/0446; H04W 72/0453

(52) U.S. Cl. CPC H04W 72/0446; H04W 72/0453

(57) ABSTRACT

Embodiments of a method performed by a radio entity are disclosed. In one embodiment, a method performed by a radio entity for transmitting a beacon signal is provided, wherein the method is performed by a radio entity which is configured to operate in a frequency band, wherein the frequency band comprises a frequency subband for which the radio entity is switchable between operating as transmitter and operating as receiver. The method comprises determining whether a first time, which is a time for transmitting the beacon signal, and a second time, which is a time for operating as transmitter nearest to the first time, satisfy a proximity condition. The method further comprises, upon determining that the first time and the second time satisfy the proximity condition, transmitting the beacon signal in the frequency subband.

### RELATED APPLICATIONS

This application claims the benefit of U.S. Provisional Patent Application No. 63/755,915, filed Feb. 7, 2025, the disclosure of which is hereby incorporated herein by reference in its entirety.

### TECHNICAL FIELD

The present disclosure relates to a technique for transmitting or receiving a beacon signal. More specifically, and without limitation, methods and devices are provided for handling Synchronization Signal/Physical Broadcast Channel Blocks (SSBs) in Subband Full Duplex (SBFD).

### BACKGROUND

New Radio (NR) standard in the 3^{rd} Generation Partnership Project (3GPP) is being designed to provide service for multiple use cases such as enhanced Mobile Broadband (eMBB), Ultra-Reliable and Low Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but may allow moderate data rates.

One solution for low latency data transmission lies in shorter transmission time intervals. In NR, in addition to transmission in a slot, a mini-slot transmission is also allowed to reduce latency. A mini-slot may consist of any number of 1 to 14 Orthogonal Frequency Division Multiplexing (OFDM) symbols. The concepts of slot and mini-slot are typically not specific to a specific service, with the consequence that a given mini-slot may be used for either eMBB, URLLC, or other services.

Besides this development, endeavors have gone into allocating frequency portions for uplink (UL) and frequency portions for downlink (DL) within a single slot, at a same time. Here UL refers to data transmission from a User Equipment (UE), or terminal, to a network node (i.e., gNodeB (gNB)), or base station, while DL refers to data transmission from the gNB to the UE. This Frequency-Division Duplexing (FDD) expands on conventionally implemented Time-Division Duplexing (TDD), where UL and DL transmissions take place sequentially in the frequency band. In particular, Subband Full Duplex (SBFD) has emerged as a duplex mode where a time division multiplex carrier is split into frequency subbands to enable simultaneous transmission and reception in the same slots. UL transmissions could be configured or dynamically scheduled. Together with cross-subband scheduling, the gNB could in this way provide a high uplink capacity and low latency to better meet the requirements of critical applications.

However, NR networks require a regular transmission of synchronization Signal/Physical Broadcast Channel Blocks (SSBs). SSBs are broadcast periodically by network nodes and are a fundamental component for initial access procedures. A burst of SSBs is transmitted at least every 20 milliseconds (ms) in cells supporting initial access, and every burst may consist of multiple SSBs, typically representing different beam directions. The SSBs allow the UE to synchronize in frequency and time to the network, and the SSBs also broadcast information that is needed by UEs in order to determine how to perform initial access attempts using the Physical Random-Access Channel (PRACH).

Transmitting SBBs therefore should be prioritized over UL transmission. So far, the idea has been to use the existing collision handling principles of existing NR TDD to achieve a prioritization of SBBs over configured or dynamically scheduled UL transmission. It is, however, unclear whether a slot comprising SSB symbols should be considered as a full DL slot (i.e., covering the full frequency band) or SSB symbols configured with SBFD subbands are SBFD symbols (i.e., allow for parallel UL transmission), where only DL receptions within DL-usable physical resource blocks are allowed for SBFD-aware UEs.

One approach may be to emphasize the SBDF configuration of time resources (such as slots or symbols) in SBDF systems, i.e., keeping SSB symbols configured with SBDF subbands as SBDF symbols (which comprise UL portions). However, this has the disadvantage that the crucial SSBs may be transmitted only in parts of the bandwidth, which leads to weaker coverage and non-predictable SSB behavior.

On the other hand, terminating UL transmission in order to transmit an SSB over the full frequency range would force the gNB antenna to reconfigure, which comes at a cost of both energy and time and makes it necessary to include a guard time where neither downlink nor uplink transmissions occur, required e.g. to avoid interference between uplink and downlink transmissions. Such an approach would therefore render the operation of the gNB more inefficient.

### SUMMARY

In view of the above, there is a need for a solution that allows for a more flexible interpretation of Subband Full Duplex (SBFD) and non-SBFD symbols with respect to Synchronization Signal/Physical Broadcast Channel Blocks (SSBs). Advantageously, the solution should enable strong SSB signals while keeping guard times at a minimum.

Embodiments of a method performed by a radio entity are disclosed. In one embodiment, a method performed by a radio entity for transmitting a beacon signal is provided, wherein the method is performed by a radio entity which is configured to operate in a frequency band, wherein the frequency band comprises a frequency subband for which the radio entity is switchable between operating as transmitter and operating as receiver. The method comprises determining whether a first time, which is a time for transmitting the beacon signal, and a second time, which is a time for operating as transmitter nearest to the first time, satisfy a proximity condition. The method further comprises, upon determining that the first time and the second time satisfy the proximity condition, transmitting the beacon signal in the frequency subband.

In one embodiment, the proximity condition is based on a temporal proximity of the first time and the second time.

In one embodiment, the proximity condition is a condition that a temporal distance between the first time and the second time is less than a fixed threshold.

In one embodiment, transmitting the beacon signal in the frequency subband is only performed upon determining that the first time and the second time satisfy the proximity condition.

In one embodiment, the radio entity is scheduled or configured to operate as a receiver at the first time, and such configuration is disregarded or overridden to transmit the beacon signal in the frequency subband upon determining that the first time and the second time satisfy the proximity condition.

In one embodiment, the radio entity is part of a communication network. In one embodiment, the communication network is a telecommunications network. In one embodiment, the radio entity is a network node of a radio access network of the telecommunications network. In another embodiment, the radio entity is a user equipment of a radio access network of the telecommunications network. In one embodiment, the beacon signal is a synchronization signal/physical broadcast channel block (SSB).

In one embodiment, the frequency subband is one of a plurality of frequency subbands comprised in the frequency band, and the radio entity is switchable between operating as transmitter and operating as receiver in each of the plurality of subbands. In one embodiment, the radio entity is configured for SBFD operation, and the first time corresponds to a SBFD resource in which the radio entity is configured to operate as a receiver in a first subset of the plurality of frequency subbands including the frequency subband and to operate as a transmitter in a second subset of the plurality of frequency subbands, wherein the first and second subsets are disjoint subsets of the plurality of frequency subbands. In one embodiment, the method further comprises, in order to enable the transmitting of the beacon signal at the first time instant, overriding an SBFD configuration for the SBFD resource such that the radio entity interprets the SBFD resource as a non-SBFD resource.

In one embodiment, the beacon signal is a signal for each transmission across an entirety of the frequency band at the first time is desired.

In one embodiment, the beacon signal is, or comprises, a synchronization signal and/or a configuration signal.

In one embodiment, the frequency subband comprises one or more frequency subcarriers and/or one or more physical resource blocks.

In one embodiment, the method further comprises detecting a time of a switch between operating as transmitter and operating as receiver, wherein the time of the switch is between the first time and the second time and shifting the time of the switch, such that the switch does not occur between the first time and the second time.

In one embodiment, the method further comprises, upon determining that the first time and the second time to not satisfy the proximity condition, transmitting the beacon signal in at least one frequency subband which is disjoint from the frequency subband but not in the frequency subband.

In one embodiment, transmission and reception of signals takes place in time resources, the first time marks a first time resource for which the radio entity is configured to operate as a receiver but for which the radio entity is also configured for transmission of the beacon signal, the second time marks a second time resource configured for transmission in the frequency subband, and the proximity condition comprises a condition that the first time resource is adjacent, in time, to the second time resource. In one embodiment, the method further comprises, upon determining that the first time and the second time satisfy the proximity condition, reinterpreting the first time resource as a time resource for which the radio entity is configured to operate as a transmitter. In one embodiment, the first time resource and/or the second time resource is one or more of the following: a slot, a half-slot or subslot, one or more consecutive symbols, all symbols in a slot at and/or after which no SSB symbols appear in case of the first time resource, and all symbols in a slot at and/or before which no SSB symbols appear in case of the first time resource. In one embodiment, the proximity condition comprises a condition that there is a further time resource where the radio entity is configured to operate as transmitter in the frequency subband such that the first time resource is immediately in-between the second time resource and the further time resource.

In one embodiment, the method further comprises receiving a message specifying whether the transmitting of the beacon signal should be performed and/or should be suppressed. In one embodiment, the message is received via at least one of the following: radio resource control (RRC) and a system information block (SIB).

In another embodiment, a method performed by a radio entity for transmitting a beacon signal, the radio entity being configured to operate in a frequency band comprising a plurality of frequency subbands for which the radio entity is switchable between operating as a transmitter and operating as a receiver, comprises, for a first time resource for which the radio entity is configured or scheduled to transmit a beacon signal but for which the radio entity is also configured to operate as a receiver in at least one frequency subband from among the plurality of frequency subbands, determining whether a proximity condition between the first time resource and a second time resource for which the radio entity is configured to operate as a transmitter in the at least one frequency subband is satisfied. The method further comprises, if the proximity condition is satisfied, transmitting the beacon signal in the at least one frequency subband in the first time resource. The method further comprises, if the proximity condition is not satisfied, operating as a receiver in the at least one frequency subband in the first time resource.

In one embodiment, the radio entity is configured for SBFD operation, and the first time resource is a SBFD resource, and transmitting the beacon signal comprises reinterpreting the SBFD resource as a non-SBFD resource. In one embodiment, the radio entity is a user equipment (UE), and reinterpreting the SBFD resource as a non-SBFD resource comprises reinterpreting the SBFD resource as either an uplink resource or a flexible resource for all of the plurality of subbands. In another embodiment, the radio entity is a network node, and reinterpreting the SBFD resource as a non-SBFD resource comprises reinterpreting the SBFD resource as either a downlink resource or a flexible resource for all of the plurality of subbands.

Embodiments of a method performed by a radio entity for receiving a beacon signal are also disclosed herein. In one embodiment, a method for receiving a beacon signal is provided, wherein the method is performed by a radio entity which is configured to operate in a frequency band, wherein the frequency band comprises a frequency subband for which the radio entity is switchable between operating as transmitter and operating as receiver. The method comprises determining whether a first time, which is a time for receiving the beacon signal, and a second time, which is a time nearest to the first time for operating as receiver, satisfy a proximity condition. The method further comprises, upon determining that the first time and the second time satisfy the proximity condition, receiving the beacon signal in the frequency subband.

In one embodiment, the proximity condition is based on a temporal proximity of the first time and the second time.

In one embodiment, the proximity condition is a condition that a temporal distance between the first time and the second time is less than a fixed threshold.

In one embodiment, receiving the beacon signal in the frequency subband is only performed upon determining that the first time and the second time satisfy the proximity condition.

In one embodiment, the radio entity is scheduled or configured to operate as a transmitter at the first time, and such configuration is disregarded or overridden to receive the beacon signal in the frequency subband upon determining that the first time and the second time satisfy the proximity condition.

In one embodiment, the radio entity is part of a communication network. In one embodiment, the communication network is a telecommunications network. In one embodiment, the radio entity is a network node of a radio access network of the telecommunications network. In another embodiment, the radio entity is a user equipment of a radio access network of the telecommunications network. In one embodiment, the beacon signal is a SSB.

In one embodiment, the frequency subband is one of a plurality of frequency subbands comprised in the frequency band, and the radio entity is switchable between operating as transmitter and operating as receiver in each of the plurality of subbands. In one embodiment, the radio entity is configured for SBFD operation, and the first time corresponds to a SBFD resource in which the radio entity is configured to operate as a transmitter in a first subset of the plurality of frequency subbands including the frequency subband and to operate as a receiver in a second subset of the plurality of frequency subbands, wherein the first and second subsets are disjoint subsets of the plurality of frequency subbands. In one embodiment, the method further comprises, in order to enable the receiving of the beacon signal at the first time instant, overriding an SBFD configuration for the SBFD resource such that the radio entity interprets the SBFD resource as a non-SBFD resource.

In one embodiment, the beacon signal is a signal for each transmission across an entirety of the frequency band at the first time is desired.

In one embodiment, the beacon signal is, or comprises, a synchronization signal and/or a configuration signal.

In one embodiment, the frequency subband comprises one or more frequency subcarriers and/or one or more physical resource blocks.

In one embodiment, the method further comprises detecting a time of a switch between operating as receiver and operating as transmitter, wherein the time of the switch is between the first time and the second time and shifting the time of the switch, such that the switch does not occur between the first time and the second time.

In one embodiment, the method further comprises, upon determining that the first time and the second time to not satisfy the proximity condition, receiving the beacon signal in at least one frequency subband which is disjoint from the frequency subband but not in the frequency subband.

In one embodiment, transmission and reception of signals takes place in time resources, the first time marks a first time resource for which the radio entity is configured to operate as a transmitter but for which the radio entity is also configured for reception of the beacon signal, the second time marks a second time resource configured for reception in the frequency subband, and the proximity condition comprises a condition that the first time resource is adjacent, in time, to the second time resource. In one embodiment, the method further comprises, upon determining that the first time and the second time satisfy the proximity condition, reinterpreting the first time resource as a time resource for which the radio entity is configured to operate as a receiver. In one embodiment, the first time resource and/or the second time resource is one or more of the following: a slot, a half-slot or subslot, one or more consecutive symbols, all symbols in a slot at and/or after which no SSB symbols appear in case of the first time resource, and all symbols in a slot at and/or before which no SSB symbols appear in case of the first time resource. In one embodiment, the proximity condition comprises a condition that there is a further time resource where the radio entity is configured to operate as receiver in the frequency subband such that the first time resource is immediately in-between the second time resource and the further time resource.

In one embodiment, the method further comprises receiving a message specifying whether the transmitting of the beacon signal should be performed and/or should be suppressed. In one embodiment, the message is received via at least one of the following: RRC and SIB.

In another embodiment, a method performed by a radio entity for receiving a beacon signal is provide, wherein the radio entity is configured to operate in a frequency band comprising a plurality of frequency subbands for which the radio entity is switchable between operating as a transmitter and operating as a receiver. The method comprises, for a first time resource for which the radio entity is configured or scheduled to receive a beacon signal but for which the radio entity is also configured to operate as a transmitter in at least one frequency subband from among the plurality of frequency subbands, determining whether a proximity condition between the first time resource and a second time resource for which the radio entity is configured to operate as a receiver in the at least one frequency subband is satisfied. The method further comprises, if the proximity condition is satisfied, receiving the beacon signal in the at least one frequency subband in the first time resource. The method further comprises, if the proximity condition is not satisfied, operating as a transmitter in the at least one frequency subband in the first time resource.

In one embodiment, the radio entity is configured for SBFD operation, and the first time resource is a SBFD resource, and receiving the beacon signal comprises reinterpreting the SBFD resource as a non-SBFD resource. In one embodiment, the radio entity is a UE, and reinterpreting the SBFD resource as a non-SBFD resource comprises reinterpreting the SBFD resource as either a downlink resource or a flexible resource for all of the plurality of subbands. In another embodiment, the radio entity is a network node, and reinterpreting the SBFD resource as a non-SBFD resource comprises reinterpreting the SBFD resource as either an uplink resource or a flexible resource for all of the plurality of subbands.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

Further details of embodiments of the technique are described with reference to the enclosed drawings, wherein:

FIG. 1 shows a schematic block diagram of an embodiment of a radio device;

FIG. 2 shows a schematic block diagram of an embodiment of a network node;

FIG. 3 shows a flowchart for a method for transmitting a beacon signal, which method may be implementable by any one of the devices of FIG. 1 and FIG. 2;

FIG. 4 shows a flowchart for a method for receiving a beacon signal, which method may be implementable by any one of the devices of FIG. 1 and FIG. 2;

FIG. 5 schematically illustrates embodiments of the devices of FIGS. 1 and 2 in a network cell;

FIG. 6 schematically illustrates a radio time-frequency grid with Orthogonal Frequency Division Multiplexing (OFDM) radio resources;

FIG. 7 schematically illustrates a subframe with OFDM symbols;

FIG. 8 schematically illustrates Frequency-Division Duplex (FDD) and Time-Division Duplex (TDD) operations and systems;

FIG. 9 schematically illustrates an uplink/downlink (UL/DL) time-frequency structure for FDD and TDD;

FIG. 10 schematically illustrates an exemplary Time Division Duplexing (TDD) DL/UL pattern consisting of S=5 slots;

FIG. 11 schematically illustrates three additional exemplary cell-specific DL/UL patterns;

FIG. 12 schematically illustrates conventional TDD carriers or carrier systems;

FIG. 13 schematically illustrates Subband Full Duplex (SBFD) systems;

FIG. 14A schematically illustrates a three-Resource-Block (3 RB) set in an SBFD symbol configured as D-U-D;

FIG. 14B schematically illustrates a 3 RB set in an SBFD symbol configured as U-D-U;

FIG. 15 schematically illustrates issues with certain locations of Synchronization Signal/Physical Broadcast Channel Blocks (SSBs) with respect to SBFD configuration;

FIG. 16 schematically illustrates advantages of the technique and a comparison to alternatives;

FIG. 17 shows a schematic block diagram of a radio device embodying the device of FIG. 1;

FIG. 18 shows a schematic block diagram of a network node embodying the device of FIG. 2; and

FIG. 19 schematically illustrates an example telecommunication network connected via an intermediate network to a host computer.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR), 5G, or 6G implementation, it is readily apparent that the technique described herein may also be implemented for successors thereof, or to any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

In view of the problems described in the Background section above, there is a need for a solution that allows for a more flexible interpretation of Subband Full Duplex (SBFD) and non-SBFD symbols with respect to Synchronization Signal/Physical Broadcast Channel Blocks (SSBs). Advantageously, the solution should enable strong SSB signals while keeping guard times at a minimum.

As to a first method aspect, a method for transmitting a beacon signal is provided, wherein the method is performed by a radio entity which is configured to operate in a frequency band, wherein the frequency band comprises a frequency subband for which the radio entity is switchable between operating as transmitter and operating as receiver. The method comprises detecting a proximity condition, based on a first time, which is a time for transmitting the beacon signal, and a second time, which is a time for operating as transmitter nearest to the first time. The method further comprises transmitting the beacon signal in the frequency subband if the proximity condition is satisfied.

In one embodiment, the beacon signal is, or comprises, a synchronization signal and/or a configuration signal.

In one embodiment, the frequency subband comprises one or more frequency subcarriers and/or one or more physical resource blocks.

In one embodiment, the method comprises detecting a time of a switch between operating as transmitter and operating as receiver, wherein the time of the switch is between the first time and the second time, and shifting the time of the switch, such that the switch does not occur between the first time and the second time.

In one embodiment, the method comprises transmitting the beacon signal, if the proximity condition is not satisfied, only in a frequency subband which is disjoint from the frequency subband.

In one embodiment, a transmission and reception of signals takes place in time resources, the first time marks a first time resource which is configured with the beacon signal, the second time marks a second time resource configured for transmission in the frequency subband, and the proximity condition comprises that the first time resource is adjacent to the second time resource.

In one embodiment, the method further comprises reinterpreting, if the proximity condition is satisfied, the first time resource as not configured as SBFD.

In one embodiment, the first time resource and/or the second time resource is one or more of the following:
a slot,
a half-slot or subslot,
one or more consecutive symbols,
in case of the first time resource, all symbols in a slot at and/or after which no SSB symbols appear,
in case of the first time resource, all symbols in a slot at and/or before which no SSB symbols appear.

In one embodiment, the proximity condition comprises that there is a further time resource where the radio entity is configured to operate as transmitter in the frequency subband such that the first time resource is immediately in-between the second time resource and the further time resource.

In one embodiment, if a preconfiguration of the radio entity stipulates that the radio entity, for the first time resource, operates as transmitter, and/or stipulates that the radio entity, for the first time resource, operates as receiver and the preconfiguration is overridden for transmitting the beacon signal, then the first time resource is configured as any one of the following:
as a downlink time resource,
as an uplink time resource,
as a flexible time resource.

In one embodiment, the method further comprises receiving a message specifying if the transmitting of the beacon signal should be performed and/or if the transmitting of the beacon signal should be suppressed.

In one embodiment, wherein the message is received via at least one of the following: Radio Resource Control (RRC) and a System Information Block (SIB).

As to a second method aspect, a method for receiving a beacon signal, wherein the method is performed by a radio entity which is configured to operate in a frequency band, wherein the frequency band comprises a frequency subband for which the radio entity is switchable between operating as transmitter and operating as receiver is provided. In one embodiment, the method comprises detecting a proximity condition, based on a first time, which is a time for receiving the beacon signal, and a second time, which is a time nearest to the first time for operating as receiver. The method further comprises receiving the beacon signal in the frequency subband if the proximity condition is satisfied. Features of the embodiments described above for the method for transmitting a beacon signal, interpreted accordingly, may be realized in the method of receiving a beacon signal.

In one embodiment, the method for receiving a beacon signal comprises receiving the beacon signal, if the proximity condition is not satisfied, only in a frequency subband which is disjoint from the frequency subband.

In one embodiment, a transmission and reception of signals takes place in time resources, the first time marks a first time resource which is configured with the beacon signal, the second time marks a second time resource configured for reception in the frequency subband, and the proximity condition comprises that the first time resource is adjacent to the second time resource.

In one embodiment, the proximity condition comprises that there is a further time resource where the radio entity is configured to operate as receiver in the frequency subband such that the first time resource is immediately in-between the second time resource and the further time resource.

In one embodiment, if a preconfiguration of the radio entity stipulates that the radio entity, for the first time resource, operates as receiver, and/or stipulates that the radio entity, for the first time resource, operates as transmitter and the preconfiguration is overridden for receiving the beacon signal, then the first time resource is configured as any one of the following:
as a downlink time resource,
as an uplink time resource,
as a flexible time resource.

In one embodiment, the method further comprises receiving a message specifying if the receiving of the beacon signal should be performed and/or if the receiving of the beacon signal should be suppressed.

As to a first product aspect, a radio entity is provided. The radio entity is configured to operate in a frequency band, wherein the frequency band comprises a frequency subband for which the radio entity is switchable between operating as transmitter and operating as receiver. The radio entity comprises a proximity condition detection module, configured to detect a proximity condition based on a first time, which is a time for transmitting or for receiving the beacon signal, and a second time, which is a time for operating as transmitter or receiver, respectively, that is nearest to the first time. The radio entity further comprises a transmission or reception module, configured to receive or transmit, respectively, the beacon signal in the frequency subband if the proximity condition is satisfied. In some embodiments, the radio entity is configured to perform the method of transmitting a beacon signal and/or the method of receiving a beacon signal in accordance with any of the embodiments described above. In particular, the radio entity may be a radio device or a network node.

As to a second product aspect, a communication network comprising the radio entity is provided.

By the aspects above, the technique comprises in particular a prescription of how to handle time resources including SSB symbols and configured as SBFD symbols or slots including SBFD symbols. Particularly, if the time resource is in immediate proximity to and/or contiguous with a non-SBFD (downlink (DL) or uplink (UL)) symbol or slot, the time resource is not considered as an SBFD time resource, whereas if the time resource is not in immediate proximity to or not contiguous with a non-SBFD symbol or slot, the time resource is considered as an SBFD time resource.

Some further aspects of the technique may in particular be described as follows.

In some embodiments, a first time resource configured as SBFD and configured with SSB symbols is not considered as an SBFD slot if a second time resource in immediate proximity to the first time resource is not considered or configured as SBFD.

Furthermore, in some embodiments, proximity may mean one or more of preceding, succeeding, preceding or succeeding, and/or preceding and succeeding.

Furthermore, in some embodiments, the first time resource can be one or more of a slot, a ½-slot or subslot, the symbols in a slot after which no SSB symbols appear, the symbols in a slot before which no SSB symbols appear, and/or Symbols including SSB symbols

Furthermore, in some embodiments, the expression ‘the second time resource immediately preceding’ the first time resource may mean one or more of the symbols immediately preceding and/or the slot immediately preceding the first time resource. Likewise, ‘the second time resource immediately succeeding’ the first time resource may mean one or more of the symbols immediately succeeding and/or the slot immediately succeeding the first time resource.

Furthermore, in some embodiments, if the first time resource is not considered or configured as SBFD, this implies that the first time resource is configured as Downlink, Flexible, or Uplink.

Furthermore, in some embodiments of the method, aspects may comprise receiving a configuration on whether the first resource should be conditionally reinterpreted (as described herein), or interpreted according to its original SBFD configuration. The configuration may be provided over SIB and/or over RRC.

Some features described herein may be based on the specifications according to “Rel-18”, 3^{rd} Generation Partnership Project (3GPP) Technical Specification (TS) 38.213, version 18.5.0, and on Rel-18 Duplex Evolution in the version of Jul. 3, 2024, and represent further developments of theses standards. As such, they may be included in a future 3GPP Rel-19 standard, or variants thereof.

Any one of the products, the radio device, the network node, the communication network or any node or station for embodying the technique may further include any feature disclosed in the context of the method aspects, and vice versa. Particularly, any one of the units and modules disclosed herein may be configured to perform or initiate one or more of the steps of the method aspects.

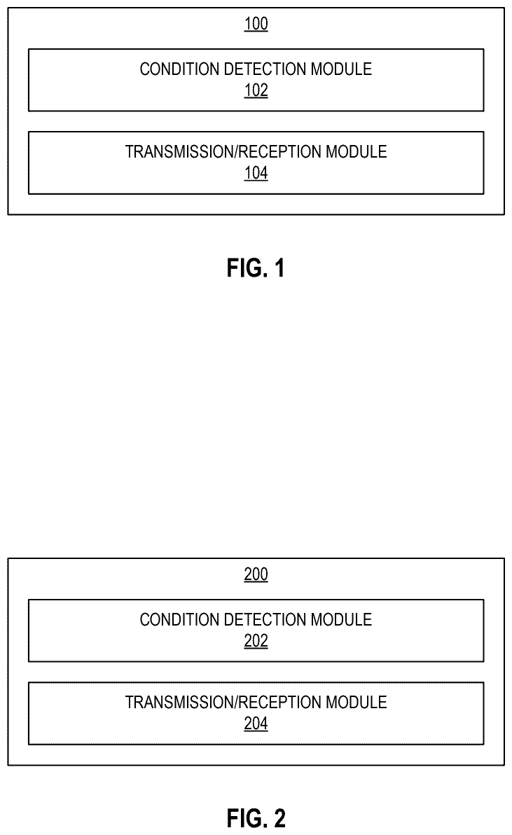

FIG. 1 schematically illustrates a block diagram of an embodiment of the radio entity, which here is a radio device 100. Illustrated is in particular that the radio device 100 is configured to carry out the method according to the second method aspect. The radio device 100 may likewise be configured to carry out the method according to the first method aspect.

The radio device 100 comprises a proximity condition detection module 102, configured to detect a proximity condition based on a first time, which is a time for receiving a beacon signal, and a second time, which is a time where the radio device 100 is configured for operating as receiver, and which is nearest to the first time.

The radio device 100 further comprises a transmission/reception module 104, which is configured to receive the beacon signal in a frequency subband if the proximity condition is satisfied.

The beacon signal may be, or comprise, a synchronization signal and/or a configuration signal, and in particular a Synchronization Signal/Physical Broadcast Channel Block (SSB).

New Radio (NR) networks regularly transmit such SSBs. A burst of SSBs is transmitted at least every 20 ms in cells supporting initial access, and every burst may consist of multiple SSBs (up to 8 in Frequency Range 1 (FR1) and up to 64 in Frequency Range 2 (FR2)), typically representing different beam directions. The SSBs allow User Equipments (UEs) to synchronize in frequency and time to the network, and the SSBs also broadcast information that is needed by UEs in order to determine how to perform initial access attempts using the Physical Random-Access Channel (PRACH).

The frequency subband may comprise one or more frequency subcarriers, and/or one or more physical resource blocks. The radio device 100 may be configured to detect a time of a switch between operating as transmitter and operating as receiver, wherein the time of the switch is between the first time and the second time, and the radio device 100 may further be configured to shift the time of the switch, such that the switch does not occur between the first time and the second time.

If the proximity condition is not satisfied, the transmission/reception module 104 may in particular be configured to receive the beacon signal only in a frequency subband which is disjoint from the frequency subband.

A transmission and reception of signals may rely on time resources. The first time may mark a first time resource which is configured with the beacon signal, and the second time may mark a second time resource, which is configured for reception in the frequency subband. The proximity condition may then comprise that the first time resource is adjacent to the second time resource. Here “adjacent” may mean either immediately preceding, or immediately following (or succeeding).

The radio device 100 may be configured to operate in SBFD mode. In this mode, time resources may be configured (and/or interpreted) as SBDF time resources (i.e., as time resources where the transmit/receive module 104 is, or is scheduled to be, operating as transmitter in some frequency subbands while operating as receiver in other frequency subbands, or in other words, where some antennas of the radio device 100 are configured for transmission while other antennas of the radio device 100 are configured for reception, or where some antennas may be used for uplink data stream while other antennas may be used for downlink data stream). However, some time resources may be configured (and/or interpreted) as non-SBFD symbols (which may e.g. mean that the transmit/receive module 104 is, or is scheduled to be, operating as transmitter or as receiver in all frequency subbands, or in other words that antennas of the radio device 100 are configured either all for transmission or all for reception, or else all for uplink or all downlink). The radio device 100 may be configured to reinterpret, if the proximity condition is satisfied, the first time resource as non-SBFD, which may override an SBFD configuration of the first time resource.

The first time resource and/or the second time resource may e.g. be one or more of a slot, a half-slot or subslot, or one or more consecutive symbols. In particular, the first time resource may correspond to all symbols in a slot at and/or after which no SSB symbols appear, or to all symbols in a slot at and/or before which no SSB symbols appear.

The proximity condition may comprise that there is a further time resource where the radio device 100 is configured to operate as receiver in the frequency subband, such that the first time resource is immediately in-between the second time resource and the further time resource.

If a SBFD time resource is conditionally reinterpreted as non-SBDF, the time resource, or parts of it, may be configured as a downlink, uplink, or flexible time resource.

The transmit/receive module may further be configured to receive a message specifying whether a beacon signal should be received in the frequency subband, and/or whether a reception of the beacon signal should be suppressed (e.g. by keeping antennas of the radio device 100 in a configuration for transmission). The message may be received by Radio Resource Control (RRC) or in a System Information Block (SIB).

In particular in the context of 5^{th} Generation (5G) or 6^{th} Generation (6G) networks or successors thereof, the radio device 100 may also be embodied as a UE.

FIG. 2 schematically illustrates a block diagram of an embodiment of the radio entity, which here is a network node 200. Illustrated is in particular that network node 200 is configured to carry out the method according to the first method aspect. The network node 200 may likewise be configured to carry out the method according to the first method aspect.

The network node 200 comprises a proximity condition detection module 202, configured to detect a proximity condition based on a first time, which is a time for transmitting the beacon signal, and a second time, which is a nearest time where the network node 200 is configured to operate as receiver. The network node 200 further comprises a transmission/reception module 204, configured to transmit the beacon signal in the frequency subband if the proximity condition is satisfied.

The network node 200 may likewise be configured to detect a time of a switch between operating as transmitter and operating as receiver, wherein the time of the switch is between the first time and the second time, and the network node 200 may further be configured to shift the time of the switch, such that the switch does not occur between the first time and the second time.

If the proximity condition is not satisfied, the transmission/reception module 204 may in particular be configured to transmit the beacon signal only in a frequency subband which is disjoint from the frequency subband.

A transmission and reception of signals may rely on time resources. The first time may mark a first time resource which is configured with the beacon signal, and the second time may mark a second time resource, where the transmission/reception module 204 is configured for transmission in the frequency subband. The proximity condition may then comprise that the first time resource is adjacent to the second time resource.

The network node 200 may be configured to likewise operate in subband full duplex (SBFD) mode.

The proximity condition may comprise that there is a further time resource where the network node 200 is configured to operate as transmitter in the frequency subband, such that the first time resource is immediately in-between the second time resource and the further time resource.

If a SBFD time resource is conditionally reinterpreted as non-SBDF, the time resource, or parts of it, may be configured as a downlink, uplink, or flexible time resource.

The transmit/receive module may further be configured to receive a message specifying whether a beacon signal should be received in the frequency subband, and/or whether a reception of the beacon signal should be suppressed (e.g. by keeping antennas of the radio device 100 in a configuration for transmission). The message may be received by radio resource control (RRC) or in a system information block (SIB).

In particular in the context of 5G or 6G networks or successors thereof, the network node 200 may also be embodied as a user next generation network node B (gNB).

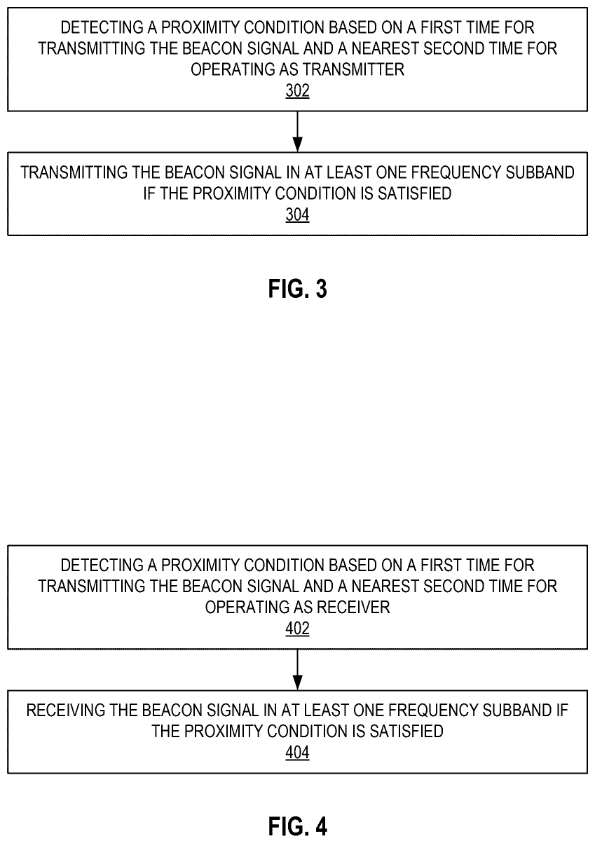

FIG. 3 shows an embodiment of a method 300 for transmitting a beacon signal. The method 300 is performed by a radio entity 100, 200 which is configured to operate in a frequency band that comprises a frequency subband for which the radio entity 100, 200 is switchable between operating as transmitter and operating as receiver. The method 300 comprises detecting 302 a proximity condition. The proximity condition may be based on a first time, which is a time for transmitting the beacon signal, and a second time, which is a time for operating as transmitter nearest to the first time. The method 300 further comprises transmitting the beacon signal in the frequency subband if the proximity condition is satisfied.

The beacon signal may be, or comprise, a synchronization signal and/or a configuration signal, and in particular an SSB. The frequency subband may comprise one or more frequency subcarriers, and/or one or more physical resource blocks. The method 300 may include detecting a time of a switch between operating as transmitter and operating as receiver, wherein the time of the switch is between the first time and the second time, and shifting the time of the switch, such that the switch does not occur between the first time and the second time. If the proximity condition is not satisfied, the method may further comprise transmitting the beacon signal only in a frequency subband which is disjoint from the frequency subband.

A transmission and reception of signals may rely on time resources, and the first time may mark a first time resource which is configured with the beacon signal while the second time may mark a second time resource configured for transmission in the frequency band. The proximity condition may then comprise that the first time resource is adjacent to the second time resource. Here “adjacent” may mean either immediately preceding, or immediately succeeding.

The radio entity 100, 200 may be configured to operate in SBFD mode. In this mode, time resources may e.g. by default, be configured (and/or interpreted) as SBDF time resources (i.e., as time resources where the radio entity 100, 200 is or is scheduled to be operating as transmitter in some frequency subbands while operating as receiver in other frequency subbands, or in other words, where some antennas of the radio entity 100, 200 are configured for transmission while other antennas of the radio entity 100, 200 are configured for reception, or else where some antennas may be used for uplink data stream while other antennas may be used for downlink data stream). However, some time resources may be configured (and/or interpreted) as non-SBFD symbols (which may e.g. mean that the radio entity 100, 200 is or is scheduled to be operating as transmitter or as receiver in all frequency subbands, or in other words, that all antennas of the radio entity 100, 200 are configured either for transmission or for reception, or for uplink or downlink). The method 300 may then comprise reinterpreting, if the proximity condition is satisfied, the first time resource as non-SBFD, which may override an SBFD configuration.

The first time resource and/or the second time resource may e.g. be one or more of a slot, a half-slot or subslot, or one or more consecutive symbols. In particular, the first time resource may correspond to all symbols in a slot at and/or after which no SSB symbols appear, or to all symbols in a slot at and/or before which no SSB symbols appear.

The proximity condition may comprise that there is a further time resource where the radio entity 100, 200 is configured to operate as transmitter in the frequency subband such that the first time resource is immediately in-between the second time resource and the further time resource.

If a SBFD time resource is conditionally reinterpreted as non-SBDF, the time resource may be configured as a downlink, uplink, or flexible time resource.

Herein, a list of the form A, B, and/or C (also written as A, B and/or C) may correspond to at least one or each of A, B, and C, i.e., A and/or B and/or C.

The method 300 may comprise receiving a message specifying whether the transmitting of the beacon signal should be performed and/or whether the transmitting of the beacon signal should be suppressed. The message may be received by radio resource control (RRC) or in a system information block (SIB).

FIG. 4 shows an embodiment of a method 400 for receiving a beacon signal. The method 400 is performed by a radio entity 100, 200 which is configured to operate in a frequency band that comprises a frequency subband for which the radio entity 100, 200 is switchable between operating as transmitter and operating as receiver. The method 400 comprises detecting 402 a proximity condition, based on a first time, which is a time for receiving the beacon signal, and a second time, which is a time nearest to the first time for operating as receiver. The method further comprises receiving 404 the beacon signal in the frequency subband if the proximity condition is satisfied.

The method 400 may be analogous to the method 300, but for receiving the beacon signal rather than for transmitting it. Thus, features described for method 300 may also be realized for method 400, mutatis mutandis.

In particular, the method 400 may further comprise receiving 404 the beacon signal, if the proximity condition is not satisfied, only in a frequency subband which is disjoint from the frequency subband.

As before, a transmission and reception of signals may rely on time resources, and the first time may mark a first time resource which is configured with the beacon signal, while the second time may mark a second time resource, configured for reception in the frequency subband. The proximity condition may then comprise that the first time resource is adjacent to the second time resource. The first time source might either immediately precede or immediately succeed the second time source.

The proximity condition may comprise that there is a further time resource where the radio entity 100, 200 is configured to operate as receiver in the frequency band, and that the first time resource lies immediately in-between the second time resource and the further time resource.

Analogously to the previous method aspect, the method 400 may comprise reinterpreting, if the proximity condition is satisfied, the first time resource as not configured as subband full duplex (SBFD), and in fact as, or effectively as, a TDD time resource. Especially in such a case, the first time resource may be configured as a downlink, uplink or flexible resource, e.g. a downlink, uplink, or flexible symbol.

The method 400 may further comprise receiving a message, or a configuration, specifying whether the receiving of the beacon signal should be performed and/or whether the receiving of the beacon signal should be suppressed. The message may be received via RRC or via a SIB.

Herein, a list of the form A, B, and/or C (also written as A, B and/or C) may correspond to at least one or each of A, B, and C, i.e., A and/or B and/or C.

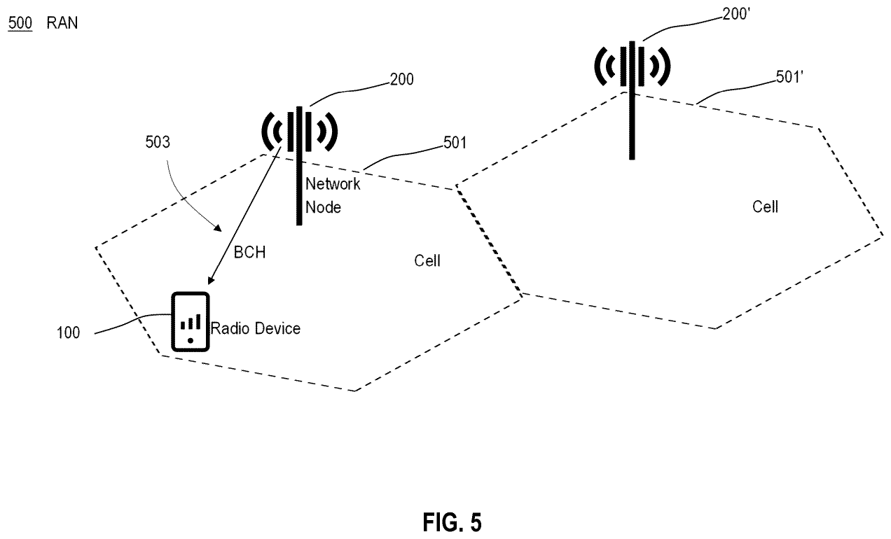

FIG. 5 illustrates an embodiment of the devices 100, 200 and shows two cells 501, 501′ of a radio access network 500 with the radio device 100, the network node 200, and a further network node 200′. Here, the radio device 100, the network node 200, and the further network node 100b may embody the radio entity 100, 200, and may consequentially be configured to carry out steps of one or more of the disclosed method aspects. In particular, the network node 200 provides data of the Broadcast Channel (BCH) to the radio device 100. The beacon signal 503 may be embodied as SSBs comprised in the BCH.

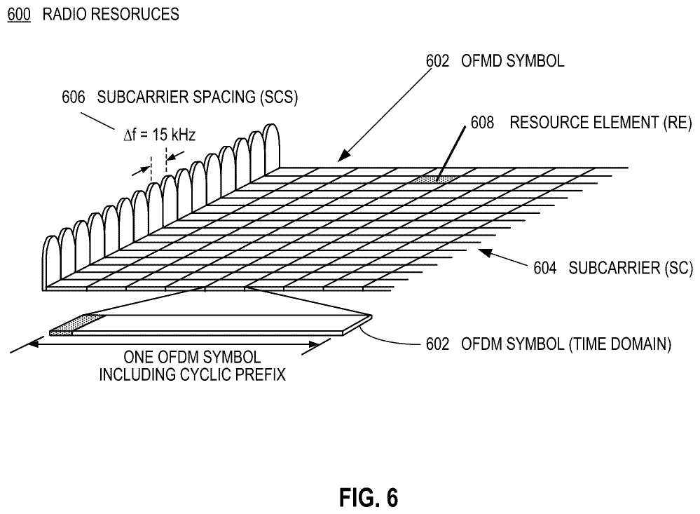

FIG. 6 illustrates a radio-time-frequency grid of radio resources 600, and an exemplary radio resource element 608 for an Orthogonal Frequency Division Multiplexing (OFDM) communication network, which may underly e.g. broadcasting or scheduling in an OFDM radio entity 100, 200 according to the embodiments of FIG. 1 or 2.

FIG. 6 shows a diagram where a horizontal direction corresponds to a time direction, while a direction perspectively pointing into FIG. 6 corresponds to a frequency direction.

The grid is composed of resource elements 608 in time and frequency. Each resource element 608 in this example spans 15 kilohertz (kHz) in the frequency direction (which may include a gap in frequency where no data is broadcast), and a certain amount of time. The frequency band comprises a plurality of subcarrier frequencies or subcarriers 604, SC. Each resource element 608 comprises a respective SC 604, such that a subcarrier spacing (SCS) 606 corresponds to 15 kHz. In other examples, the SCS 606 may follow a different pattern, which may in particular be defined by a concept known as “numerology”. SCS 606 may for example measure 30, 60, 120 or 240 kHz.

A physical resource block may be defined as some number, e.g. 12, of consecutive subcarriers in the frequency domain.

FIG. 6 also illustrates OFDM symbols 602. An OFDM symbol 602 may for example be defined as a collection of all resource elements 608 at a given time, comprising all frequency subbands in the frequency band. One OFDM symbol 602 is represented in a foreground. It comprises a time span reserved for a cyclic prefix in an OFDM symbol signal.

An OFDM symbol may be an example for a time resource. Based on the OFDM symbols, a hierarchy of further time resources may be defined. For example, a NR slot typically consists of several OFDM symbols, e.g. according to current agreements either 7 or 14 symbols if the OFDM subcarrier spacing is less than or equal 60 kHz, and 14 symbols if the OFDM subcarrier spacing is greater than 60 kHz.

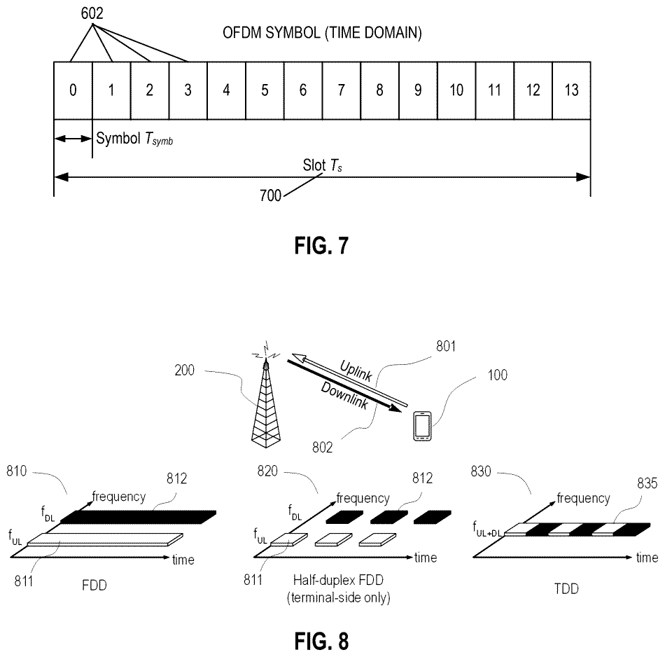

FIG. 7 shows a subframe of one slot 700 with 14 OFDM symbols 602. In this Figure, Tₛ and T_{symb} denote a duration of the slot 700 and a duration of an OFDM symbol 602, respectively.

FIG. 8 illustrates Frequency-Division Duplex (FDD) and Time-Division Duplex (TDD) operations and systems.

In an upper part, FIG. 8 shows a network node 200, such as a gNB or a terminal, and a radio device 100 or User Equipment (UE). Indicated are arrows for an uplink (UL) corresponding to UL data 801 transmitted from the UE to the gNB, and a downlink (DL) corresponding to DL data 802 transmitted from the gNB to the UE. Any of the gNB or UE may embody the radio entity 100, 200 disclosed herein, and any of them may be configured to perform the methods as disclosed herein.

In a lower part, FIG. 8 shows three diagrams 810, 820, 830. For each of these diagrams 810, 820, 830, a horizontal direction corresponds to a time direction, while a direction perspectively pointing into the Figure plane corresponds to a frequency direction.

A diagram 810 on a left side of Fig. illustrates an FDD operation for any one of the radio entities 100, 200 shown in the upper part, e.g. of the gNB 200. The radio entity 100, 200 may be configured for OFDM operation. The diagram 810 shows two exemplary frequency subbands 811, 812, wherein one frequency subband 811 is employed by the radio entity 100, 200 for UL data 801 and one frequency subband 812 is employed for DL data 802. UL data 801 and DL data 802 may be broadcast (i.e. transmitted or received) at the same time. In this case, the radio entity 100,200 may be configured for subband full duplex, SBFD, operation.

A diagram 830 on a right side of FIG. 8 illustrates a TDD operation for any one of the radio entities 100, 200 shown in the upper part, e.g. of the UE 100. The radio entity 100, 200 may or may not be configured for OFDM operation. The diagram 830 however shows that both UL data 801 and DL data 802 are broadcast in a single frequency band 835 (no subbands), with UL and DL data broadcasting taking place at different times.

A diagram 820 in the middle of FIG. 8, in between the diagram 810 on the left side and the diagram 830 on the right side, illustrates a mixed form of FDD and TDD operation; in this case, a half-duplex FDD operation. The operation may again be performed by any one of the radio entities 100, 200 shown in the upper part, e.g. of the gNB 200. The radio entity 100, 200 may be configured for OFDM operation. The diagram 820 shows two exemplary frequency subbands 821, 822, wherein one frequency subband 821 is employed by the radio entity 100, 200 for UL data 801 and one frequency subband 822 is employed for DL data 802. UL data 801 and DL data 802 may be broadcast (i.e. transmitted or received) at the same time.

In some conventional communication networks, according to Rel-15 NR, a UE 100 may be configured with up to four carrier bandwidth parts in the downlink, with a single downlink carrier bandwidth part being active at a given time. A UE 100 can also be configured with up to four carrier bandwidth parts in the uplink with a single uplink carrier bandwidth part being active at a given time.

FIG. 8 illustrates that in FDD and TDD systems, transmission and reception from a node 200 or a terminal 100 in a cellular system can be multiplexed in the frequency domain or in the time domain (or combinations thereof). FDD, as illustrated by the diagram 810 on the left side, implies that downlink and uplink transmission take place in different, sufficiently separated, frequency bands 811, 812. TDD, as illustrated by the diagram 830 on the right side, implies that downlink and uplink transmission take place in different, non-overlapping time slots. Thus, TDD can operate in unpaired spectrum, whereas FDD requires paired spectrum.

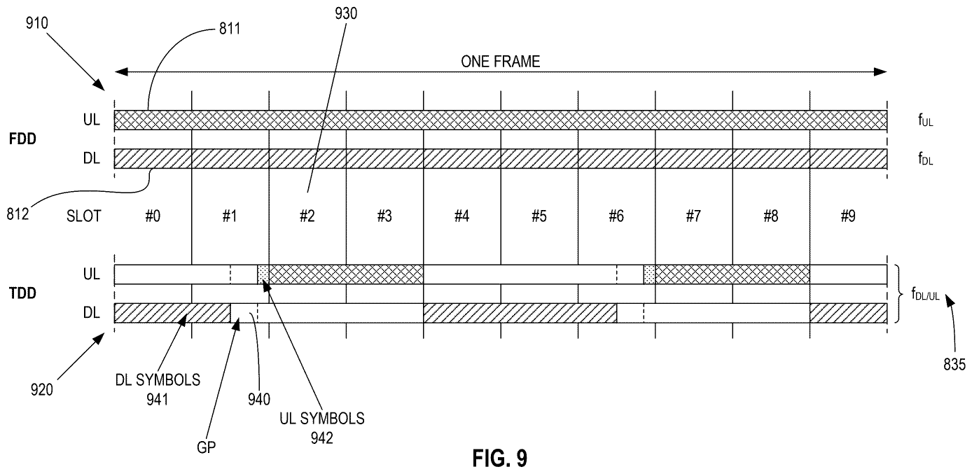

FIG. 9 illustrates an UL/DL time-frequency structure in case of FDD or TDD.

Typically, a broadcast (transmitted or received) signal in a communication system is organized in the form of a frame structure.

An upper part of FIG. 9 shows a FDD frame 910, comprising an exemplary UL frequency subband 811 (e.g. comprising an UL carrier frequency f_{UL}) and an exemplary DL frequency subband 812 (e.g. comprising a different DL carrier frequency f_{DL}). A horizontal direction corresponds to a time direction. The frame 910 may be subdivided into consecutive slots 930. For example, new radio, NR, uses ten equally sized slots 930 per radio frame for the case of 15 kHz subcarrier spacing. The slots 930 are numbered from 0 to 9.

At least with respect to a terminal or UE 100 in a cellular communication system, FDD can be either full duplex or half duplex. In the full duplex case, a terminal 100 may transmit and receive simultaneously, while in half-duplex operation, the terminal 100 cannot transmit and receive simultaneously (the base station or network node 200 is capable of simultaneous reception/transmission though, e.g. receiving from one terminal 100 while simultaneously transmitting to another terminal 100′). In Long Term Evolution (LTE), a half-duplex terminal is monitoring/receiving in the downlink except when explicitly being instructed to transmit in a certain subframe.

A lower part of FIG. 9 shows a TDD frame 920. The TDD frame 920 may comprise a single frequency band 835 (no subbands) at a carrier frequency f_{DL, UL}. At any given time, data may either be uploaded or downloaded. The frame 920 is again divided into e.g. ten slots 930. There are particular slots 930 (in this example the slots numbered 1 and 4), or particular transitions of slots 930 (in this example the transition between slot numbered 3 and slot numbered 4, and the transition between slot 930 numbered 8 and slot 930 numbered 9) where a switch between upload to download, i.e. instances where the radio entity 100, 200 switches between operating as transmitter and operating as receiver, takes place.

In case of TDD operation, there is thus only a single carrier frequency (or the full frequency bandwidth may be effectively employed in an analogous same way), and uplink and downlink transmissions may always be separated in time, also on a cell basis. As the same carrier frequency is used for uplink and downlink transmission, both the base station (network node 200) and the mobile terminals (UEs 100) need to switch from transmission to reception and vice versa.

An essential aspect of any TDD system is to provide the possibility for a sufficiently large guard time 940 where neither downlink nor uplink transmissions occur. This is required to avoid interference between uplink and downlink transmissions. For NR, this guard time is provided by special subframes, which are split into three parts: symbols 941 for DL, a guard period 940 (GP), and symbols 942 for UL. The remaining subframes are either allocated to uplink or downlink transmission.

In more detail, for conventional systems the following two information elements (IEs) are defined in conventional specifications. Similar IEs may also be defined in extended form in systems with radio entities 100, 200 according to the present disclosure. The TDD pattern is typically configured with at least a first IE, which is referred to as TDD-DL-UL-ConfigCommon and is cell-specific, and optionally a second IE, which is referred to as TDD-DL-UL-ConfigDedicated and is UE-specific.

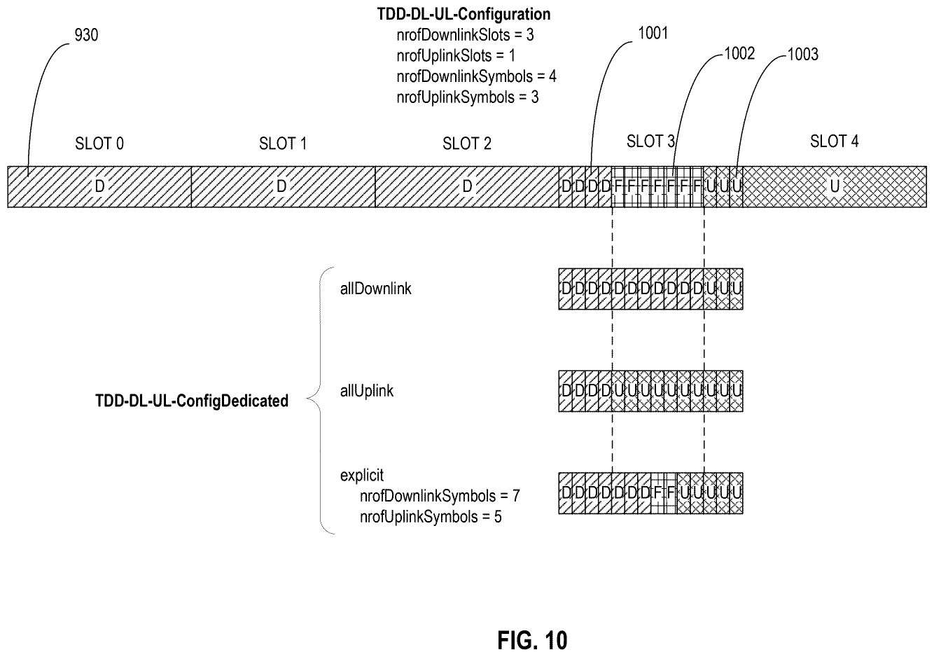

The first IE being cell specific means that it applies in common to all UEs 100 in a cell. It may be provided by broadcast signaling. It may provide the number of slots 930 in the TDD pattern via a reference subcarrier spacing and a periodicity, e.g. such that an S-slot pattern repeats every S slots. The first IE may allow for very flexible configuration of the pattern characterized e.g. as follows:
a number of full downlink slots 930 at the beginning of the pattern configured by the parameter nDownlinkSlots,
a number of full uplink slots 930 at the end of the pattern configured by the parameter nUplinkSlots,
a number of downlink (‘D’) symbols 941 following the full downlink slots configured by the parameter nDownlinkSymbols,
a number of uplink (‘U’) symbols 942 preceding the full downlink slots configured by the parameter nUplinkSlots.
If there is a gap 940 between the last downlink symbol 941 and the first uplink symbol 942, then all symbols in the gap 940 may be characterized as flexible (‘F’). A symbol classified as ‘F’ can be used for downlink or uplink. A UE 100 may determine the direction in one of the following two ways:
   Detecting a DCI that schedules/triggers a DL signal/channel, e.g., PDSCH, CSI-RS or schedules/triggers an UL signal/channel, e.g. PUSCH, SRS, etc.
   By dedicated (UE-specific) signaling of the IE TDD-DL-UL-ConfigDedicated. This parameter overrides some or all of the ‘F’ symbols in the pattern, thus providing a semi-static indication of whether a symbol is classified as ‘D’ or ‘U’.
Optionally, a 2nd pattern that is concatenated to the first pattern may be configured as above. If a 2nd pattern is configured, a constraint may be that a sum of the periodicities of the two patterns must evenly divide 20 ms. FIG. 10 illustrates an exemplary TDD DL/UL pattern consisting of S=5 slots 930. Shown is an exemplary TDD DL/UL pattern configured by TDD-DL-UL-ConfigCommon. It consists of 3 full ‘D’ slots 1001 (on the left), 1 full ‘U’ slot 1003 (on the right), with a mixed slot in-between, consisting of 4 ‘D’ symbols 1001 and 3 ‘U’ symbols 1003. The remaining 7 symbols 1002 in the mixed slot are classified as ‘F.’

If a radio device, or UE, is not configured with TDD-DL-UL-ConfigDedicated, then the pattern at the top of the diagram is what it assumes. As stated above, the network can make use of the ‘F’ symbols flexibly, by scheduling/triggering either an uplink or a downlink signal/channel in a UE specific manner. This allows for very dynamic behavior: the direction is not known to the UE a priori; rather, the direction becomes known once the UE detects a DCI scheduling/triggering a particular DL or UL signal/channel.

In contrast, the DL/UL direction for some or all of the ‘F’ symbols in a particular slot can be provided to the UE in a semi-static manner by RRC configuring the UE with TDD-DL-UL-ConfigDedicated. The lower part of FIG. 10 shows 3 exemplary configurations for overriding ‘F’ symbols in Slot 3. If the IE indicates ‘allDownlink’ or ‘allUplink’ for a particular slot (or slots), then all ‘F’ symbols in the slot are converted to either ‘D’ or ‘U,’ respectively. If the IE indicates ‘explicit,’ then a number of symbols at the beginning of the slot and/or a number of symbols at the end of the slot are indicated as ‘D’ and ‘U,’ respectively. In the example below, the first 7 and the last 5 are indicated as ‘D’ and ‘U’, which converts some of the ‘F’ symbols (but not all in this example) to ‘D’ and ‘U.’

The key behavior in the above is that the UE-specific IE TDD-DL-UL-ConfigDedicated can only override (i.e., specify ‘D’ or ‘U’) for symbols that are configured as ‘F’ by the cell-specific IE TDD-DL-UL-ConfigCommon. In other words, a UE does not expect to have a ‘D’ symbol converted to ‘U’ or vice versa.

Embodiments of the technique may keep the features as defined in this figure. In particular, if an SBFD time resource comprising the beacon signal, which may e.g. consist of one or more symbols, is overridden and treated as a non-SBFD time resource, it may considered and treated as a TDD time resource. This time resource may be configured to correspond to DL-, F- or U-symbols 1001, 1002, 1003.

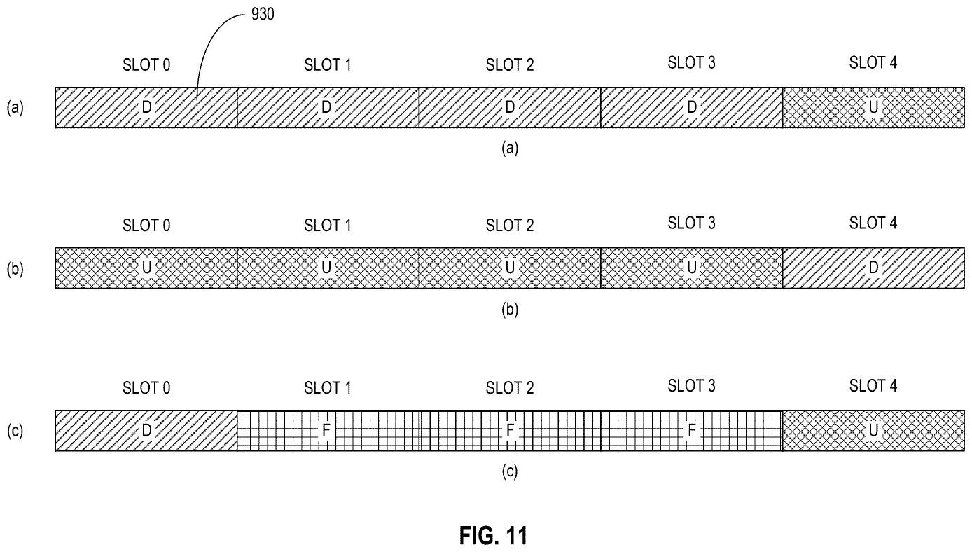

FIG. 11 illustrates three additional exemplary cell-specific DL/UL patterns. There are three additional exemplary TDD DL/UL patterns (a), (b), (c), arranged from top to bottom, which are configured by TDD-DL-UL-ConfigCommon. In the first and second patterns (a) and (b), there are no ‘F’ symbols. Each pattern comprises 5 slots 930. According to conventional specifications, a UE would not expect to be configured with TDD-DL-UL-ConfigDedicated. In contrast, in the third pattern (c), all symbols in Slots 1, 2, and 3 are configured as ‘F;’ hence, the UE could be configured with TDD-DL-UL-ConfigDedicated to provide a direction (‘D’ or ‘U’) for any or all symbols in these 3 slots. Conventional specifications, such as Rel-17, allow the dedicated configuration of the TDD pattern on a slot-specific basis. In other words, TDD-DL-UL-ConfigDedicated is not restricted to be the same in each slot where ‘F’ symbols are overridden.

In embodiments of the technique as proposed here, time resources comprising the beacon signal may be entire slots, and once a slot is converted from SBFD to non-SBFD, it may be treated as a TDD-slot, allowing for a configuration of these slots by e.g. TDD-DL-UL-ConfigDedicated, or a successor of this parameter.

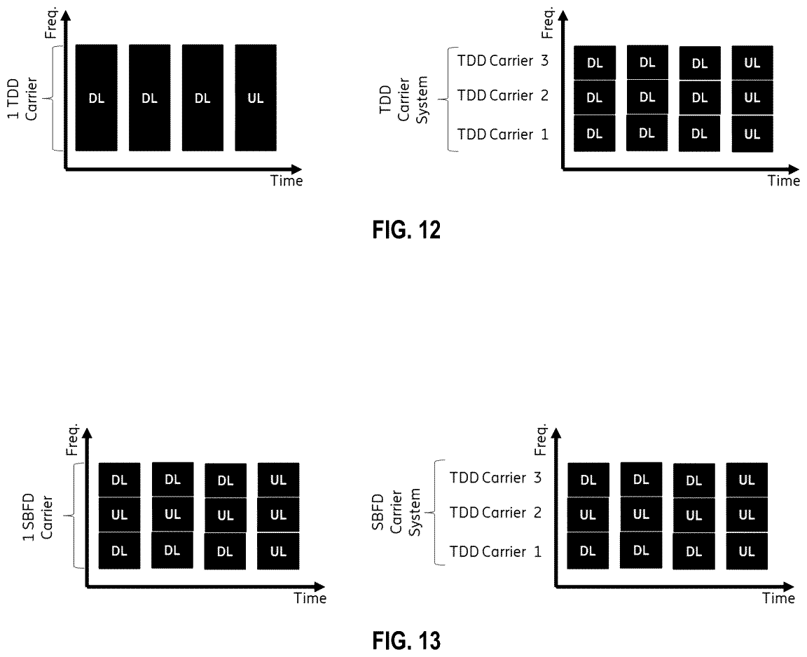

FIG. 12 illustrates conventional TDD carriers or carrier systems. As described before, in a conventional TDD system, entire carrier BW or all carriers in the same frequency band need to be utilizing the same DL transmission or UL reception directions. The figure illustrates this further.

In particular, FIG. 12 shows on a left-hand side a conventional TDD system where the entire bandwidth is used for DL transmission in the first three slots.

On a right-hand side of the figure, another conventional TDD system which utilizes all carriers for the same DL or UL directions is shown.

Similarly to this configuration, in embodiments of the technique disclosed herein, SBFD time resources comprising the beacon signal which satisfy the proximity condition may be converted to non-SBFD slots encompassing the full bandwidth.

FIG. 13 illustrates SBFD systems. In specifications of the NR system, 3GPP has decided to study the technical feasibilities and potential benefits of SBFD systems.

In such a system, a portion of a wide bandwidth carrier may be used for a different direction than that of the rest of the carrier. This is illustrated in the left-hand side of FIG. 13. That is, unlike a conventional TDD system as shown on the left-hand side of FIG. 12 where the entire bandwidth is used for DL transmission in the first three slots, the center portion of the SBFD carrier is used for UL reception while, the rest of the carrier continues to be used for DL transmission as shown in the left-hand side of FIG. 13.

Similarly, instead of utilizing all carriers for the same DL or UL directions in a conventional TDD system as shown in the right-hand side of FIG. 12, some carriers in the SBFD system can be used for a different direction than that of the other carriers, as shown in the right-hand side of FIG. 13.

In recent 3GPP-literature, in particular in Rel-18 study, the scope has been limited such that in SBFD operation, only gNBs transmit DL and receive UL simultaneously. An individual UE is scheduled in only one direction (DL or UL) at a time.

In the 3GPP Rel-18 study, the scope has been limited such that in SBFD operation, only gNBs transmit DL and receive UL simultaneously. An individual UE is scheduled in only one direction (DL or UL) at a time.

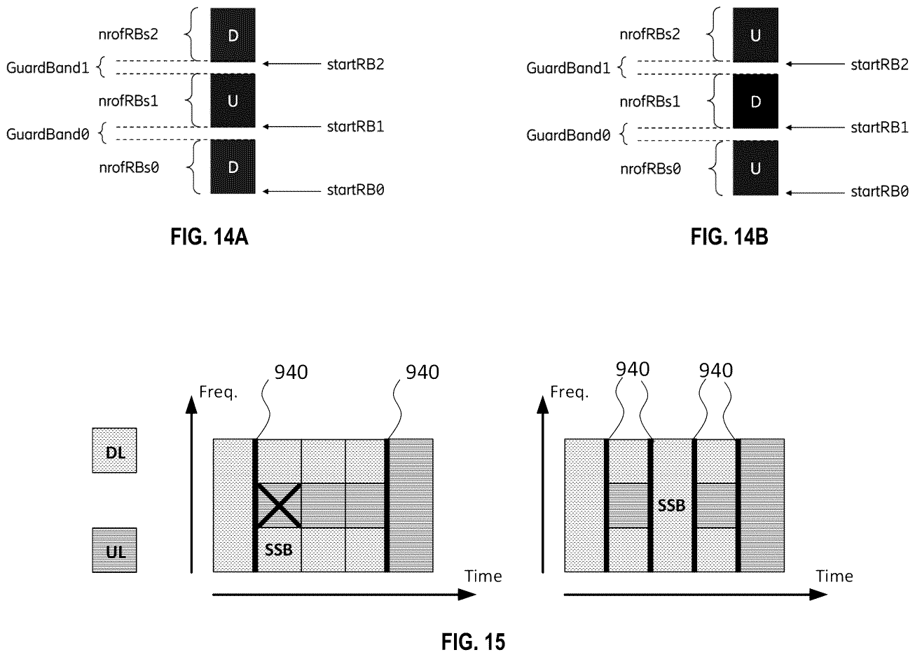

FIG. 14A illustrates a three-resource-block (3 RB) set in an SBFD symbol configured as D-U-D.

In Rel-19, RAN1 has agreed to configure one or more OFDM symbols of a slot with two or more “RB sets” (subbands) where each RB set corresponds to a frequency domain subband and has a defined transmission direction (‘D’ or ‘U’). The RB sets may have gaps between them that serve as guardbands where neither DL or UL transmission occurs. FIG. 14A shows a first exemplary RB set configuration with D-U-D configuration.

The RB sets may be configured either by introduction of new RRC parameter(s) or enhancement of an existing RRC parameter, e.g., TDD-UL-DL-ConfigDedicated. In either case, the parameter(s) signal the size and frequency domain location of the RB sets as well as which symbols/slots in the TDD UL/DL pattern may be configured with RB sets.

FIG. 14B illustrates a 3 RB set in an SBFD symbol configured as U-D-U, in an otherwise same context as in FIG. 14A.

FIG. 15 illustrates issues with certain locations of SSBs with respect to SBFD configuration.

SSBs are periodically transmitted in order for a UE to obtain time and frequency synch towards a network and to receive fundamental information about the location of SIB1. SSBs can be flexibly configured in order to suit a great many different network varieties. Inevitably, some SSBs may collide with SBFD symbols in an SBFD network. To some extent it is possible to avoid collisions, but a very rigid interpretation of SBFD symbols will unnecessarily restrict SSB configurations or cause SSBs to collide with SBFD symbols. There are several consequences of a too rigid interpretation of symbols containing SSBs whether they are interpreted as SBFD or non-SBFD symbols:
If the symbol is interpreted as SBFD symbol, as depicted on FIG. 15 on a left side, the network needs to split its antenna elements on DL and UL operation, as is the case for SBFD symbols, SSBs in SBFD symbols may have a reduced range compared to SSBs in non-SBFD symbols and/or not be able to use the UL part (e.g., UL subband) of the symbols.
Alternatively, if the SSB symbols within in the SBFD configuration are instead configured as non-SBFD symbols, as depicted in FIG. 15 on a right side, implying all antenna elements can be used for transmitting SSBs in the SSB symbols, unnecessarily many guard periods 940 due to HW reconfigurations may need to be introduced to manage the transitions between non-SBFD and SBFD symbols.

The technique disclosed herein allows for a more flexible interpretation of SBFD and non-SBFD symbols with respect to SSB. It furthermore allows for more SSB configurations using all antenna elements for DL transmissions without introducing more guard periods 940.

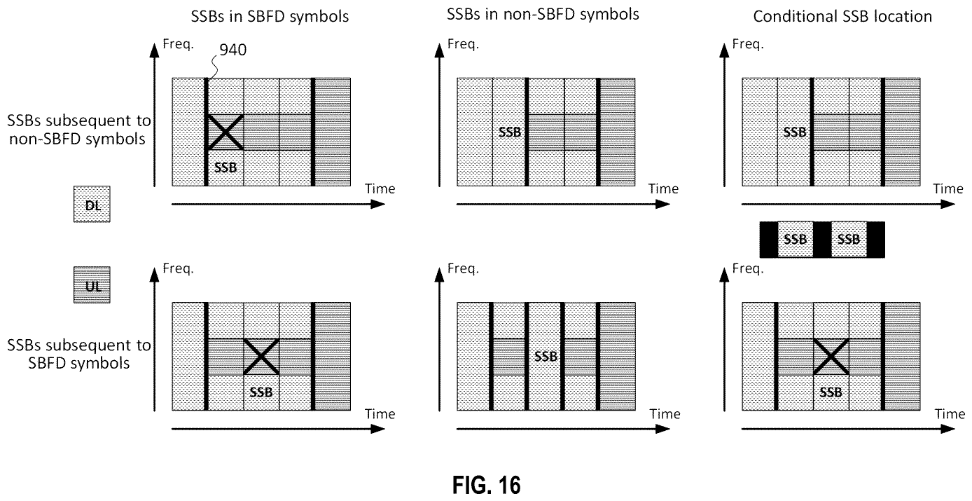

FIG. 16 schematically presents the technique disclosed herein in comparison with alternatives, and illustrates advantages of the technique.

Embodiments of the technique disclosed herein prescribe how to handle time resources with a beacon signal, which may in particular be time resources including SSB symbols and configured as SBFD symbols or slots including SBFD symbols.

In particular embodiments, if the time resource is in immediate proximity to and/or contiguous with a non-SBFD (DL, UL or F) symbol or slot, the time resource is not considered as an SBFD time resource, whereas if the time resource is not in immediate proximity to or not contiguous with a non-SBFD symbol or slot, the time resource is considered as an SBFD time resource. What is described here as SSB symbols is equally valid, and can also be implemented, for an SSB slot, and may in particular also include symbols which are preceding and/or succeeding SSBs in a slot.

An SSB slot can be a slot where the radio entity 100, 200, in particular e.g. the radio device 100, is informed of a presence of an SSB. This may be implemented e.g. by an indication via a parameter by employing e.g. higher-layer signaling or configuration, and in particular by parameter such as ssb-PositionsInBurst, or a successor thereof. In one possible variant, for the purpose of the methods 300, 400, a slot is considered as an SSB slot if the radio device 100 is informed of presence of at least one SSB within the slot. In another possible variant, a slot is only considered an SSB slot if the radio device 100 is informed of presence of all SSBs that fall within the slot.

In a further possible variant, SSB symbols are considered to be symbols where the radio device 100 is informed of a presence of an SSB.

In yet another variant, the term SSB symbols may refer to symbols where the radio device 100 is informed of a presence of an SSB, plus the symbols extending to the beginning or end of the slot towards the adjacent non-SBFD slot. For example, if an SSB is located in symbols 2,3,4,5 (with 0 being the first symbol of a slot) and the preceding slot is a non-SBFD slot, symbols 0,1,2,3,4,5 may be reinterpreted as, i.e. would not be considered to be, SBFD time resources. Similarly, if an SSB is located in symbols 8,9,10,11 and the succeeding slot is a non-SBFD slot, symbols 8,9,10,11,12,13 would not be considered to be SBFD time resources. Similarly, if two SSBs are located in symbols 2,3,4,5 and 8,9,10,11, and the preceding slot is a non-SBFD slot, symbols 0,1,2,3,4,5,6,7,8,9,10,11 would not be considered to be SBFD time resources.

A left side of FIG. 16 shows two diagrams, one on the top and one on the bottom, which may be employed to illustrate a recently proposed prior art handling the SSB symbols. The upper diagram shows a time resource comprising an SSB as an embodiment of the beacon signal second position. The time resource is preceded by a guard time 940 due to a rearrangement of antennae between the non-SBFD time resource at the first position, immediately preceding the SBFD time resource. The lower diagram shows an SBFD-configured time resource comprising the SBB at a third position, in between two time resources which are also SBFD-configured. According to a one prior art handling, the SSB symbols (or time resources including SSBs) always maintain their configuration as SBFD symbols. This, however, can lead to a relatively low signal strength for the SSB. In embodiments of the technique disclosed herein, SSBs in non-SBFD time resources to non-SBFD time resources adjacent (as in the upper diagram) will be converted to (or considered as) SBFD slots. However, for SSBs in non-SBFD slots which are sufficiently remote, the SSB time resource will remain a non-SBFD time resource.

A middle part of FIG. 16 again shows two diagrams, one on the top and one on the bottom, which may be employed to illustrate an advantage over a different approach to handle the SSB symbols. In this different approach, the SSB symbols may never maintain their configuration as SBFD (i.e., they may always be treated as non-SBFD time resources). The SBFD configuration is disregarded or not considered, and the SSB symbols are instead reverted back to their original TDD pattern configuration or configured or considered as DL (or F). In one conventional implementations of this approach, slots with SSB symbols are considered as DL slots. The technique provides improvements over this approach since only SSB time resource which are adjacent (or close enough) to non-SBFD slots will be handled as non-SBFD time resources. Some embodiments of the proposed method additionally comprise that while the SBFD configuration is reverted back to the original TDD configuration, it may also be treated as F (or UL, e.g. in the case that the UE transmits the beacon signal) time resource, and thus generalize the prior art handling, allowing for a more flexible handling of SSB time resources.

In the rightmost side of the figure, two diagrams (again one on top and one on bottom) illustrate an embodiment of the technique disclosed herein. The SSB symbol configuration are conditioned on the SBFD pattern. SSB symbols maintain their configuration as SBFD symbols only if the SSB symbols are not immediately preceded by non-SBFD symbols. Otherwise, the SBFD configuration is reverted, disregarded, or not considered, and the symbols are instead configured or considered as non-SBFD, i.e., DL (or F).

The two rows in FIG. 16 show the configuration cases where (at the top) the SSB is located in the first SBFD slot, and (at the bottom) where the SSB is located in a subsequent SBFD slot. For the top row the conditional SSB symbols configuration is identical to the configuration where SSB symbols are considered as non-SBFD (middle). Especially in the diagram on the top right, the resources in the UL subband can be used for DL traffic (and thus strengthen the beacon signal), whereas for the leftmost figure, these resources are unused.

In the bottom row, the conditional SSB location shown in the right diagram configures its symbol to SBFD symbols. In relation to the middle SSBs in non-SBFD symbols, it is possible to avoid the guard periods 940, associated with the SBFD-to-DL and DL-to-SBFD transitions associated with the change of symbol type. Although this comes at the expense of an unused UL resource during the SSB transmission, this can be beneficial, since the guard periods can be avoided.

In another embodiment of the disclosed technique (not illustrated here), the SSB slot, if immediately preceding an UL slot, is interpreted or configured as a DL or F slot depending on the original TDD configuration. Benefits corresponding to those explained before can be obtained.

In a further embodiment, the behavior is configurable such that information on how to configure the UE may be provided by e.g. the remaining minimum system information SIB1, e.g. as part of an (enhanced) parameter servingCellConfigCommonSIB, or in a new field.

This information could include that the conditional SSB location is one or more of the following:
Enabled,
Disabled,
Enabled if a preceding resource is a non-SBFD resource (what constitutes a resource is described above)
Enabled if a succeeding resource is a non-SBFD resource,
Enabled if either a preceding or a succeeding resource is a non-SBFD resource (what constitutes a resource is described above),
Enabled if both a preceding and a succeeding resource is a non-SBFD resource (what constitutes a resource is described above).

In yet another embodiment, the behavior is configurable in such a way that information on how to configure the radio device 100 may be provided within the parameter ServingCellConfigCommon via CellGroupConfig, which is used to configure cell specific parameters of a UE's serving cell. By means of this, the network may provide this information in the form of dedicated signalling to SBFD-aware UEs (i.e., radio devices 100) only when configuring a UE with a SCells or with an additional cell group (SCG).

In a variant of this embodiment, the behavior is configurable such that information on how to configure the UE is provided by SIB1 as part of an enhanced parameter servingCellConfigCommonSIB or a new field, and/or within ServingCellConfigCommon via CellGroupConfig. The information may be configured as indicated in the above list for the further embodiment where the behavior is configurable by SIB1.

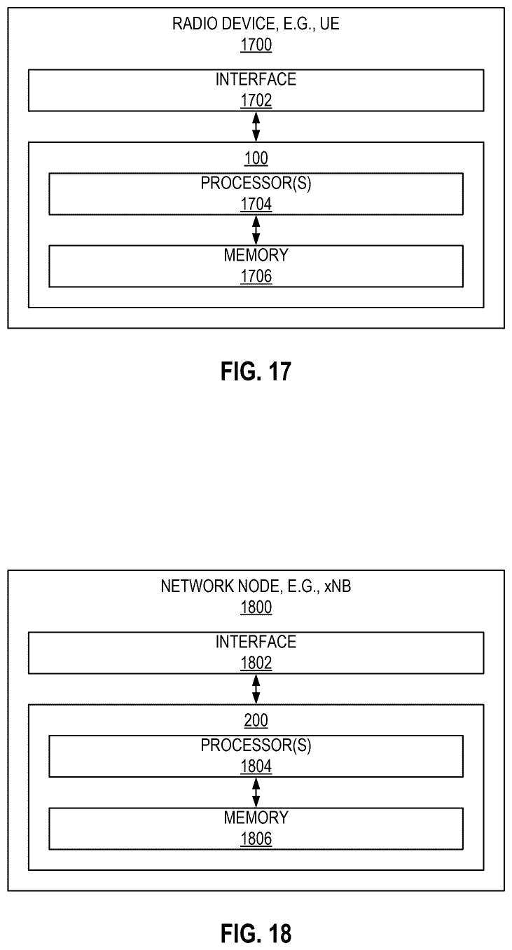

FIG. 17 shows a schematic block diagram for an embodiment of the device 100. The device 100 comprises processing circuitry, e.g., one or more processors 1704 for performing the method 300 and memory 1706 coupled to the processors 1704. For example, the memory 1706 may be encoded with instructions that implement at least one of the modules 102 and 104. The one or more processors 1704 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1706, radio device functionality. For example, the one or more processors 1704 may execute instructions stored in the memory 1706. Such functionality may include providing various features and steps discussed herein, including any of the benefits disclosed herein. The expression “the device being operative to perform an action” may denote the device 100 being configured to perform the action.

As schematically illustrated in FIG. 17, the device 100 may be embodied by a radio device 1700, e.g., functioning as a UE. The radio device 1700 comprises a radio interface 1702 coupled to the device 100 for radio communication with one or more network nodes, e.g., functioning as a base station of the RAN.

FIG. 18 shows a schematic block diagram for an embodiment of the device 200. The device 200 comprises processing circuitry, e.g., one or more processors 1804 for performing the method 400 and memory 1806 coupled to the processors 1804. For example, the memory 1806 may be encoded with instructions that implement the module 202 or 204.

The one or more processors 1804 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1806, network node functionality. For example, the one or more processors 1804 may execute instructions stored in the memory 1806. Such functionality may include providing various features and steps discussed herein, including any of the benefits disclosed herein. The expression “the device being operative to perform an action” may denote the device 200 being configured to perform the action.

As schematically illustrated in FIG. 11, the device 200 may be embodied by a network node 1800, e.g., functioning as a base station. The network node 1800 comprises a radio interface 1802 coupled to the device 200 for radio communication with one or more radio devices, e.g., functioning as a UE.

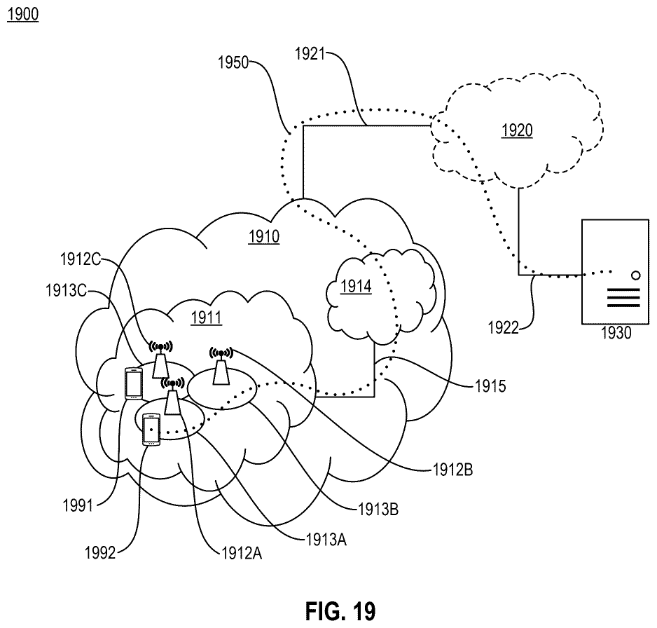

With reference to FIG. 19, in accordance with an embodiment, a communication system 1900 includes a telecommunication network 1910, such as a 3GPP-type cellular network, which comprises an access network 1911, such as a radio access network, and a core network 1914. The access network 1911 comprises a plurality of base stations 1912a, 1912b, 1912c, such as NBs, eNBs, gNBs or other types of wireless access points, each defining a corresponding coverage area 1913a, 1913b, 1913c. Each base station 1912a, 1912b, 1912c is connectable to the core network 1914 over a wired or wireless connection 1915. A first user equipment (UE) 1991 located in coverage area 1913c is configured to wirelessly connect to, or be paged by, the corresponding base station 1912c. A second UE 1992 in coverage area 1913a is wirelessly connectable to the corresponding base station 1912a. While a plurality of UEs 1991, 1992 are illustrated in this example, the disclosed embodiments are equally applicable to a situation where a sole UE is in the coverage area or where a sole UE is connecting to the corresponding base station 1912.

Any of the base stations 1912 and the UEs 1991, 1992 may embody the network node 200 and radio device 100, respectively.

The telecommunication network 1910 is itself connected to a host computer 1930, which may be embodied in the hardware and/or software of a standalone server, a cloud-implemented server, a distributed server or as processing resources in a server farm. The host computer 1930 may be under the ownership or control of a service provider, or may be operated by the service provider or on behalf of the service provider. The connections 1921, 1922 between the telecommunication network 1910 and the host computer 1930 may extend directly from the core network 1914 to the host computer 1930 or may go via an optional intermediate network 1920. The intermediate network 1920 may be one of, or a combination of more than one of, a public, private or hosted network; the intermediate network 1920, if any, may be a backbone network or the Internet; in particular, the intermediate network 1920 may comprise two or more sub-networks (not shown).

The communication system 1900 of FIG. 12 as a whole enables connectivity between one of the connected UEs 1991, 1992 and the host computer 1930. The connectivity may be described as an over-the-top (OTT) connection 1950. The host computer 1930 and the connected UEs 1291, 1992 are configured to communicate data and/or signaling via the OTT connection 1950, using the access network 1911, the core network 1914, any intermediate network 1920 and possible further infrastructure (not shown) as intermediaries. The OTT connection 1950 may be transparent in the sense that the participating communication devices through which the OTT connection 1950 passes are unaware of routing of uplink and downlink communications. For example, a base station 1912 need not be informed about the past routing of an incoming downlink communication with data originating from a host computer 1930 to be forwarded (e.g., handed over) to a connected UE 1991. Similarly, the base station 1912 need not be aware of the future routing of an outgoing uplink communication originating from the UE 1991 towards the host computer 1930.

As has become apparent from above description, at least some embodiments of the technique enables increasing efficiency in the network with regard to beacon signals, and in particular SSBs, since the technique can provide a balance between keeping a number of switching operations between transmission and reception functionality in the radio entity 100, 200 to a minimum (up to not introducing any further switches at all) on the one hand, while providing a higher reliability of the beacon signals, at least compared to a pure SBFD implementation of the beacon signals.

In this way, the disclosed technique allows for a more flexible interpretation of SBFD and non-SBFD symbols with respect to SSB. It furthermore allows for more SSB configurations using all antenna elements for DL transmissions without introducing more guard periods.

In the radio entity 100, 200, switching from either transmission to reception or from reception to transmission in the frequency subband may cost energy and take time. On the other hand, the beacon signal can be of fundamental importance in the communication network, and it may therefore be beneficial to transmit over a frequency range which is as broad as possible. By only transmitting the beacon signal in the frequency subband if, at or in a proximity of the time for the transmission of the beacon signal, the radio entity 100, 200 is scheduled to transmit in the frequency subband anyway, a broader frequency range can be covered if the cost is low, while a beacon signal can still be transmitted in other frequency subbands (disjoint from the frequency subband) if the time for transmitting the beacon signal falls within a time span where the radio entity 100, 200 is switched to operate as a receiver in the frequency subband, and the time for transmitting the beacon signal is distant from any time where the radio entity 100, 200 is switched to operate as a transmitter in the frequency subband (i.e., if the proximity condition is not satisfied.

In particular, in telecommunication networks where the radio entity 100, 200 is configured for orthogonal frequency division multiplexing, OFDM, and for subband full duplex, SBFD, operation, switching between non-SBFD and SBFD symbols typically incurs a cost in that the radio entity 100, 200 needs to be reconfigured. During that time the radio entity 100, 200 may have to interrupt its operation or service. For example, if the radio entity 100, 200 is a network node such as a gNB, interruptions typically last 10 μs for FR1 and 3 μs for FR2, according to agreements in RAN4, or one symbol for all specified FR1 and FR2 subcarriers.

When transmitting the beacon signal, in particular an SSB, it may be desirable that all antenna elements are utilized to provide as strong coverage as possible, and to provide predictable SSB behavior. This is typically true regardless of whether the SSB is transmitted in SBFD or non-SBFD symbols. However, if the beacon signal is transmitted over a broader frequency range, receiving (Rx) operation in respective resources of the SBFD symbol will cease, since the Rx antennas will be needed for SSB transmission (Tx), leaving the SBFD UL (upload) subband unused during the SSB transmission.

The method and product aspects disclosed can provide a trade-off between resource utilization regarding switching costs and unused UL subbands during Synchronization Signal/PBCH, SS, transmission, since they can implement a more sophisticated configuration of SSB resources in SBFD symbols or slots., the proposed method may address one of the topics of interest in 3GPP Release 19 UE-initiated and/or event-driven reporting as well as in 6G.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following exemplary embodiments.

Embodiment 1: A method (300) for transmitting a beacon signal (503), wherein the method (300) is performed by a radio entity (100, 200) which is configured to operate in a frequency band, wherein the frequency band comprises a frequency subband for which the radio entity (100, 200) is switchable between operating as transmitter and operating as receiver, the method (300) comprising:
detecting a proximity condition, based on a first time, which is a time for transmitting the beacon signal (503), and a second time, which is a time for operating as transmitter nearest to the first time; and
transmitting the beacon signal (503) in the frequency subband if the proximity condition is satisfied.

The first time may be a characteristic time at which the beacon signal is transmitted, is to be transmitted, or is scheduled for transmission by the radio entity. The first time may also refer to, be comprised in, or mark, a particular time period for transmitting the beacon signal.

The second time may refer to the point in time at which the radio entity operates, should be operating, or is scheduled to operate, as transmitter which is closest to the first time. In other words, the proximity condition may be based on a smallest distance between the (scheduled) first time and any time at which the radio entity operates, or is scheduled to operate, as transmitter in the frequency subband. Analogously to the first time, the second time may refer to, be comprised in, or mark a time period at which some particular further signal may be transmitted over the frequency subband. The second time may come after or before the first time, or coincide with the first time. A distance between times, and in particular the smallest distance, may in general be non-negative, i.e. positive or zero. The first time and the second time may take values in a discrete set, wherein a spacing between any two elements in the discrete set is bounded below by a minimum cut-off. The distance may then be measured, and/or indicated, in units of the minimum cut-off. The minimum cut-off may correspond to the smallest unit of time in a radio time-frequency grid associated with the radio entity.

The proximity condition may generally be based on a temporal proximity of the first time and the second time. The proximity condition may be, or comprise, that the (smallest) distance between the first time and the second time is smaller than a fixed threshold.

The detecting may be performed when the transmission of the beacon signal and the configuration of the radio entity to operate as transmitter are merely scheduled, i.e. when the first time and the second time are still in the future.

The transmitting may in particular be performed only if the proximity condition is satisfied.

The transmitting implies that if the radio entity is scheduled or configured to operate as receiver at the first time (i.e. there exists a preconfiguration of the radio entity to operate as receiver when the beacon signal is to be transmitted), this is disregarded (i.e., the preconfiguration is not considered, or overridden).

One effect of the method can be that a number of switches performed by the radio entity becomes restricted, compared to a situation where the where the beacon signal is transmitted in the frequency subband in all cases. In order to perform the transmitting, the radio entity must operate as transmitter in the frequency subband. Thus, the transmitting may imply that the radio entity performs a switch in such a way that it is enabled to transmit the beacon signal in the frequency subband at the first time. Advantageously, this switch is compensated by not having to perform a switch in-between the nearest transmission time and the first time. However, even if the transmitting leads to one or more further switches, due to the proximity condition the number of switches may still end up being reduced compared to a situation where the beacon signal is transmitted in the frequency subband in all cases.

The radio entity may be part of a communication network. The communication network may thus comprise the radio entity.

The communication network may be a telecommunication network, in particular according to a Third Generation Partnership Project (3GPP) technical specification. The telecommunication network may e.g. be a 5G or 6G network, or a successor thereof.

If the communication network is a telecommunication network, the radio entity may be a network node (or a base station) of a Radio Access Network, RAN, or of a core network comprised in the telecommunication network. However, the radio entity may also be a radio device (or terminal device, or user equipment, UE). The radio entity may thus be mobile, and/or configured to connect to and to disconnect from a rest of the telecommunication network.

The communication network may also be a wireless local area network, in particular according to the IEEE 802.11 family of standards, or according to a successor thereof.

If the communication network is a wireless local area network, the radio entity may be an element of a service set. The radio entity may be an access point of the wireless local area network. The radio entity may be a portable device, and/or configured to connect to or to disconnect from a rest of the wireless local area network.

The frequency band may comprise a plurality of frequency subbands, and among these frequency subbands is the frequency subband where the radio entity is switchable between operating as transmitter and operating as receiver. The plurality of frequency subbands may cover the frequency band. The plurality of frequency subbands may cover the frequency band up to gaps in frequency where no transmission or reception takes place. Each frequency subband may comprise, and optionally be characterized by, a carrier frequency for radio signal broadcasting. The frequency subbands of the plurality of frequency subbands may be arranged within the frequency band in a particular pattern. The pattern may be according to a subband standard of 3GPP. A frequency subband may correspond to a subcarrier, or it may comprise one or more subcarriers. The pattern may be the pattern employed for orthogonal frequency division multiplexing, OFDM, in the communication network. If the communication system or the radio entity is configured for OFDM broadcasting, they may be referred to as OFDM communication system or OFDM radio entity, and so on. At any given time, any of the frequency subbands of the plurality of frequency subbands may be selected for either transmission or reception of signals by the radio entity. The radio entity may be configured to switch between operating as a transmitter or a receiver individually for any one of the frequency subbands of the plurality of frequency subbands, or for individual carriers. The radio entity may also be configured to switch only for groups of carriers, such as for individual physical resource blocks.

If the communication network is a telecommunication network, the radio entity may for example be a network node or base station (e.g. a next generation node B, gNB), or a radio device (or terminal, or user equipment, UE). If the communication network is a wireless local area network, the radio entity may be a member of or for a service set.

The radio entity may be configured to transmit and/or to receive radio signals in the frequency band. The radio entity may be configured for frequency division duplexing (FDD). Thus, in particular, the radio entity may be configured to perform downlink and uplink transmissions at a same time (or within a same time period), taking place in different, sufficiently separated, frequency subbands.

The radio entity may also be configured for time division duplexing (TDD). Thus, the radio entity may be configured to enable downlink and uplink transmission in different, non-overlapping time periods, for any or all frequency subbands.

The radio entity may thus be configured to employ one or more frequency subbands and specific times or time periods for transmission or reception of a message, using FDD, TDD, and/or a mixture of FDD and TDD (such as half-duplex FDD). Examples where this configuration encompasses the full frequency band may be referred to as Subband Full Duplex (SBFD). Thus, the radio entity may be configured for SBFD operation. It may be referred to as an SBFD radio entity, or the communication system may be referred to as an SBDF communication system.

In particular, the radio entity may be switchable between operating as transmitter and operating as receiver for each frequency subband comprised in the frequency subband individually. A way in which the radio entity operates at any given time in the frequency subband may be defined in a way depending on a protocol, a policy, and/or a standard. It may furthermore be predetermined depending on stored data in a memory of the radio entity, and/or depending on information received from a further entity in the communication network. The radio entity may eventually be configured to allocate which frequency subbands and times (or time periods) are to be used for uplink and downlink, respectively. For example, in a telecommunication network, if the radio entity is a radio device or user equipment, UE, it may be configured based e.g. on a radio resource control, RRC, protocol. For TDD, RRC parameters referred to as information elements, comprising TDD-DL-UL-ConfigCommon and TDD-DL-UL-ConfigDedicated, have conventionally been defined to configure the radio device to operate as transmitter or receiver. An SBFD radio entity may be configured to operate as transmitter or receiver in each relevant frequency subband by similar RRC parameters. These parameters may be enhancements of conventional parameters, such as those mentioned for TDD, or they may be new parameters.

The radio entity may thus initially have a configuration to operate as transmitter or receiver (for SBFD, this may be referred to as an SBFD configuration) at any given time, and in particular at the first time. For performing the transmitting of the beacon signal, the radio entity may however have to change a pattern of operating as a transmitter and operating as a receiver, thereby effectively overriding the SBFD configuration. This may also be referred to as “not considering” the SBFD configuration.

The beacon signal may be any signal for which broadband transmission is desired. The beacon signal may be transmitted periodically, or scheduled for periodic transmission, by the radio entity. The beacon signal may be configured to convey or indicate basic information for enabling a communication between the radio entity and other components of the communication network.

An effect of this method is that if the beacon signal is scheduled for transmission at or around some time (the first time) which is in proximity of another time (the second time) at which the radio entity is configured to employ the frequency subband for transmission anyway, the beacon signal will also be transmitted in the frequency subband. This may include that a switch takes place to configure the radio entity to operate as transmitter in the frequency subband at the time of transmitting the beacon signal. However, if the first time is remote from boundaries of a time span during which the radio entity operates as receiver in the frequency subband, the beacon signal is not transmitted in the frequency subband. It may still be transmitted in other frequency subbands of the plurality of frequency subbands.

This method can be employed to provide a balance between reducing a number of switches and reliably transmitting the beacon signal. On the one hand, in the radio entity, switching from either transmission to reception or from reception to transmission in the frequency subband may cost energy and take time. On the other hand, the beacon signal may be of fundamental importance in the processes of the communication network, and it may therefore be beneficial to transmit over a frequency range which is as broad as possible. The method provides the functionality that the beacon signal is transmitted in the frequency band where the radio entity is switchable in dependence on a proximity of an operation as transmitter. if the By only transmitting the beacon signal in the frequency subband if, at or in a proximity of the time for the transmission of the beacon signal, the radio entity is scheduled to transmit in the frequency subband anyway, a broader frequency range can be covered if the cost is low, while a beacon signal can still be transmitted in frequency subbands other than the frequency subband if the first time falls within a time span where the radio entity is switched to operate as a receiver in the frequency subband, and the first time is sufficiently remote from any time where the radio entity operates, or is scheduled to operate, as a transmitter in the frequency subband (i.e., if the proximity condition is not satisfied).

The following embodiments provide advantageous implementations with more specifics.

Embodiment 2: The method (300) according to embodiment 1, wherein the beacon signal (503) is, or comprises, a synchronization signal and/or a configuration signal.

The synchronization signal may be configured to be employed by other entities in the communication network to detect and synchronize to a timing of the radio entity, or of another entity in the communication network.

The synchronization signal may e.g. be configured to help a UE to identify a frame boundary of an overall transmitted signal, of which the synchronization signal may be a part. The synchronization signal may be configured to provide additional synchronization information, e.g. information that allows the UE to distinguish between different cells and/or determine a cell identity, or provide a finer timing synchronization in relation to the cell.

The configuration signal may carry essential system information that allows e.g. a UE to understand how to connect and communicate with the network. The configuration signal may comprise critical information like a system bandwidth, a number of cells, and other network configuration parameters.

In a telecommunication network, the beacon signal may thus be, comprise, or be comprised in a synchronization signal/PBCH block, SSB (or a successor of the SSB). Accordingly, the beacon signal may e.g. be or comprise a primary synchronization signal, PSS, a secondary synchronization signal, SSS, and/or at least one block in a physical broadcast channel (PBCH).

In a wireless local area network, the beacon signal may be, comprise, or be comprised in a WLAN beacon signal, or in a WLAN beacon signal frame.

Embodiment 3: The method (300) according to any one of the previous embodiments, wherein the frequency subband comprises one or more frequency subcarriers, and/or one or more physical resource blocks.

The subcarriers (SCs) and the physical resource blocks (PRBs) may follow a 3GPP specification. An individual frequency subband where the radio entity is switchable between operating as transmitter and operating as receiver may comprise only consecutive SCs or PRBs.

Embodiment 4: The method (300) according to any one of the previous embodiments, wherein the method (300) includes:
detecting a time of a switch between operating as transmitter and operating as receiver, wherein the time of the switch is between the first time and the second time, and
shifting the time of the switch, such that the switch does not occur between the first time and the second time.

This detecting and/or shifting may be performed only if the proximity condition is satisfied. The switch may be a switching operation performed by the radio entity. When performing the detecting, the transmission of the beacon signal and the switch may be merely scheduled, i.e., the first time and the time of the switch may be in the future. The shifting may then comprise performing the switch already before the first time. However, in other cases only the first time (for transmitting the beacon signal) may still be in the future when the detecting is performed. The shifting may then comprise postponing the switch until after the transmission of the beacon signal has taken place. The shifting may in particular be realized by reconfiguring the radio entity such that it operates as transmitter over the full frequency spectrum in-between (and including) the first time and the second time.

Embodiment 5: The method (300) according to any one of the preceding embodiments, wherein the method comprises transmitting the beacon signal (503), if the proximity condition is not satisfied, only in frequency subband which is disjoint from the frequency subband.

If no transmission is scheduled within the frequency subband in proximity of the first time, then the beacon signal may thus only be transmitted in other parts of the frequency band. In the frequency subband which is disjoint from, i.e. non-overlapping with, the frequency subband, the radio entity may operate as transmitter at all times, or over a prolonged time, or an analogous proximity condition may be satisfied. The radio entity may operate as transmitter at all times either e.g. because in the disjoint frequency subband, the radio entity is not configured to switch, because of resource allocation, or because of a policy, procedure or standard applied in the communication network.

There may thus be at least two cases in which the beacon signal is transmitted: In a first case the proximity condition is satisfied and the beacon signal is transmitted both in the frequency subband as well as in the disjoint frequency subband. In advantageous examples, the beacon signal may be transmitted over all frequency subbands in the frequency band. In a second case the proximity condition is not satisfied, and the beacon signal is transmitted at most in one or more frequency subbands which are disjoint from the frequency subband.

In some examples there may be a respective proximity condition for every frequency subband in the plurality of subbands, and the beacon signal may be transmitted exactly in those frequency subbands where the respective proximity condition is satisfied. In other words, the frequency band may comprise a first and a second frequency subband, and so on, which are mutually disjoint, i.e. non-overlapping, and the method may comprise determining a first proximity condition related to the first frequency subband, and a second proximity condition related to the second frequency subband, and so on, and the method may further comprise transmitting the beacon signal in the first frequency subband if (and/or only if) the first proximity condition is satisfied, and transmitting the beacon signal in the second frequency subband if (and/or only if) the second proximity condition is satisfied, and so on.

However, in some examples, a configuration of the beacon signals as well as times or periods when the beacon signal will be transmitted may depend on the respective frequency subband.

Embodiment 6: The method (300) according to any one of the preceding embodiments, wherein a transmission and reception of signals takes place in time resources, the first time marks a first time resource which is configured with the beacon signal (503), the second time marks a second time resource configured for transmission in the frequency subband, and the proximity condition comprises that the first time resource is adjacent to the second time resource.

Time resource may refer to a temporal unit for transmission and/or reception of radio signals. The second time may in particular mark a second time resource for which the radio entity is configured as transmitter in the frequency subband. Time resources may follow a sequential ordering. The first time resource and the second time resource may be adjacent if in this ordering, the first time resource immediately succeeds the second time resource, or vice versa. While the first time resource and the second time resource may be non-overlapping, they may refer to different time spans.

For each time resource, the radio entity may be operating, or scheduled to be operating, as transmitter or as a receiver in the frequency subband, and optionally in each frequency subband comprised in the frequency subband or in the frequency band, respectively. The above description in terms of “times” may also hold for “time resources”.

A time resource being “configured” for reception or transmission in any frequency subband may mean that the radio entity is correspondingly configured. If the radio entity (or another entity in the communication system) is configured for SBFD operation, each time resource may be referred to as being “configured for SBDF” if there are frequencies where the radio entity operates as transmitter and frequencies where the radio entity operates as receiver in (or during) this time resource. In contrast, time resources in which in at least some frequency subbands (in particular any of the frequency subband) the configuration is overridden, e.g. for performing the transmitting of the beacon signal, may be referred to as “not considered SBFD”.

In embodiments, aspects of the method may therefore be formulated in the way that a first time resource configured as SBFD and configured with SSB symbols is not considered as an SBFD slot if a second time resource in immediate proximity to the first time resource is not considered or configured as SBFD.

In examples, time resources may be associated with a subdivision into the frequency bands, and elements of this subdivision may be referred to as time-frequency resources.

For an SBDF radio entity or SBDF communication system, in particular in telecommunication, the time resource may refer to a (whole) slot, to a half-slot (or other sub-slot), to all symbols in a slot at or after which no part of the beacon signal (e.g., no SSB symbol) appears, to all symbols in a slot at or before which no part of the beacon signal (e.g., no SBB symbol) appears, or simply to all symbols which together comprise the beacon signal, e.g. to all SSB symbols.

Embodiment 7: The method according to embodiment 6, wherein the method comprises reinterpreting, if the proximity condition is satisfied, the first time resource as not configured as subband full duplex, SBFD.

The first time resource may initially be or not be configured for SBFD. The reinterpreting may comprise a reconfiguration of the radio entity from receiving to transmitting for the first time resource. This may include changing a state of components of the radio entity (e.g. from RX to TX, or which subband filters are active, or implementing a guard interval or guard pause). Generally, the radio entity may be configured initially (before the transmitting of the beacon signal) to operate as transmitter or receiver, and the method may lead to changing that configuration, depending on whether the proximity condition is satisfied. Performing the reinterpreting only if the proximity condition is satisfied may also be referred to as “conditionally reinterpreting” the initial configuration (in general), or as “conditionally reinterpreting” the first time resource.

Embodiment 8: The method (300) according to any one of the embodiments 6 or 7, wherein the first time resource and/or the second time resource is one or more of the following:
a slot,
a half-slot or subslot,
one or more consecutive symbols,
in case of the first time resource, all symbols in a slot at and/or after which no SSB symbols appear,
in case of the first time resource, all symbols in a slot at and/or before which no SSB symbols appear.

The first time resource may therefore be one or more of a slot, a half-slot or a subslot, or one or more consecutive symbols comprising the beacon signal, which may e.g. be one or more SSB symbols. The second time resource may be the symbol immediately preceding or immediately succeeding the first time slot, or the slot immediately preceding or immediately succeeding the first time slot.

Embodiment 9: The method (300) according to any one of the embodiments 6 to 8, wherein the proximity condition comprises that there is a further time resource where the radio entity (100, 200) is configured to operate as transmitter in the frequency subband such that the first time resource is immediately in-between the second time resource and the further time resource.

The second time resource may be immediately succeeding the first time resource, in which case the further time resource should be immediately preceding the first time resource for the proximity condition to be satisfied, or the second time resource may be immediately preceding the first time resource, in which case the further time resource should be immediately preceding the first time resource for the proximity condition to be satisfied.

Embodiment 10: The method (300) according to any one of the embodiments 6 to 9, wherein if a preconfiguration of the radio entity (100, 200) stipulates that the radio entity (100, 200), for the first time resource, operates as transmitter, and/or stipulates that the radio entity (100, 200), for the first time resource, operates as receiver and the preconfiguration is overridden for transmitting the beacon signal (503), then the first time resource is configured as any one of the following:
as a downlink time resource,
as an uplink time resource,
as a flexible time resource.

In other words, if the radio entity is stipulated to operate as transmitter at the time scheduled for transmitting the beacon signal, or if the transmitting of the beacon signal implies that the radio entity effectively operates as transmitter for transmitting the beacon signal, then the radio entity may configure corresponding symbols as uplink, downlink, or flexible symbols. This may imply that the radio entity acts as transmitter over the full frequency band for the first time resource. In particular, this may imply that the first time resource at which the radio entity transmits the beacon signal is effectively configured as non-SBFD and/or as a TDD time resource.

Embodiment 11: The method (300) according to any one of the preceding embodiments, wherein the method (300) comprises receiving a message specifying if the transmitting of the beacon signal (503) should be performed and/or if the transmitting of the beacon signal (503) should be suppressed.

In any one of the embodiments 6 to 9, the method may comprise receiving a message (or receiving a configuration) specifying whether the first resource should be conditionally reinterpreted, or whether an original configuration should be maintained. The message (or configuration) may act to override the method. The message may be a configuration message which the radio entity may receive from another entity in the communication network.

Embodiment 12: The method (300) according to embodiment 11, wherein the message is received via at least one of the following:
radio resource control, RRC,
a system information block, SIB.

The RRC and the SIB may play the same role as in conventional telecommunication networks.

Embodiment 13: A method (400) for receiving a beacon signal (503), wherein the method (400) is performed by a radio entity (100, 200) which is configured to operate in a frequency band, wherein the frequency band comprises a frequency subband for which the radio entity (100, 200) is switchable between operating as transmitter and operating as receiver, the method (400) comprising:
detecting a proximity condition, based on a first time, which is a time for receiving the beacon signal (503), and a second time, which is a time nearest to the first time for operating as receiver; and
receiving the beacon signal (503) in the frequency subband if the proximity condition is satisfied.

Embodiment 14: The method (400) according to embodiment 13, wherein the method (400) comprises any of the features disclosed in embodiments 2 to 12.

This method aspect may thus include any of the aspects as disclosed in the first method aspect for a situation where the radio entity is not a transmitter or the beacon signal, but a receiver of the beacon signal. The radio entity may thus be scheduled for receiving, or expecting to receive, the beacon signal at the first time, and may override a configuration as transmitter in the frequency band. In particular, the first time may here be a characteristic time at which the beacon signal is received, is to be received, or is scheduled for reception by the radio entity. The second time may refer to the point in time at which the radio entity operates, should be operating, or is scheduled to operate, as receiver which is closest to the first time.

The detecting may be performed when the reception of the beacon signal and the configuration of the radio entity to operate as receiver are merely scheduled, i.e. when the first time and the second time are still in the future.

The receiving may in particular be performed only if the proximity condition is satisfied.

The radio entity may be part of a communication network, in particular a telecommunication or wireless local area network. The communication network may thus comprise the radio entity.

The frequency band may comprise a plurality of frequency subbands, as indicated for the first method aspect.

The radio entity may be a network node or a radio device, with a configuration for OFDM, FDD, TDD and/or SBFD as in the first method aspect.

As in the previous method aspect, the beacon signal may be, or comprise, a synchronization signal and/or a configuration signal.

As in the previous method aspect, the frequency subband may comprise one or more frequency subcarriers, and/or one or more physical resource blocks.

Analogously to the previous method aspect, the method may include detecting a time of a switch between operating as transmitter and operating as receiver, wherein the time of the switch is between the first time and the second time, and shifting the time of the switch, such that the switch does not occur between the first time and the second time.

Embodiment 15: The method (400) according to any one of the embodiments 13 or 14, wherein the method (400) comprises receiving the beacon signal (503), if the proximity condition is not satisfied, only in a frequency subband which is disjoint from the frequency subband.

In particular, analogously to the previous method aspect, the radio entity may be configured not to operate as a receiver in the frequency subband. As in the previous method aspect, there may be a respective proximity condition for every frequency subband. A configuration of the beacon signals as well as times or periods when the beacon signal will be received may depend on the respective frequency subband.

Embodiment 16: The method (400) according to any one of the embodiments 13 to 15, wherein a transmission and reception of signals takes place in time resources, the first time marks a first time resource which is configured with the beacon signal (503), the second time marks a second time resource configured for reception in the frequency subband, and the proximity condition comprises that the first time resource is adjacent to the second time resource.

As in the previous method aspect, time resource may refer to a (whole) slot, to a half-slot (or other sub-slot), to all symbols in a slot at or after which no part of the beacon signal (e.g., no SSB symbol) appears, to all symbols in a slot at or before which no part of the beacon signal (e.g., no SBB symbol) appears, or simply to all symbols which together comprise the beacon signal, e.g. to all SSB symbols. The second time may in particular mark a second time resource for which the radio entity is configured as receiver in the frequency subband.

Analogously to the previous method aspect, the method may comprise reinterpreting, if the proximity condition is satisfied, the first time resource as not configured as subband full duplex (SBFD).

As in the previous method aspect, the first time resource and/or the second time resource may be one or more of a slot, a half-slot or subslot, one or more consecutive symbols, in case of the first time resource, all symbols in a slot at and/or after which no SSB symbols appear, and, in case of the first time resource, all symbols in a slot at and/or before which no SSB symbols appear.

Embodiment 17: The method (400) according to embodiment 16, wherein the proximity condition comprises that there is a further time resource where the radio entity (100, 200) is configured to operate as receiver in the frequency subband such that the first time resource is immediately in-between the second time resource and the further time resource.

As in the first method aspect, the second time resource may be immediately succeeding the first time resource, in which case the further time resource should be immediately preceding the first time resource for the proximity condition to be satisfied, or the second time resource may be immediately preceding the first time resource, in which case the further time resource should be immediately preceding the first time resource for the proximity condition to be satisfied.

Embodiment 18: The method (400) according to any one of the embodiments 16 or 17, wherein if a preconfiguration of the radio entity (100, 200) stipulates that the radio entity (100, 200), for the first time resource, operates as receiver, and/or stipulates that the radio entity (100, 200), for the first time resource, operates as transmitter and the preconfiguration is overridden for receiving the beacon signal (503), then the first time resource is configured as any one of the following:
as a downlink time resource,
as an uplink time resource,
as a flexible time resource.

In other words, if the radio entity is stipulated to operate as receiver at the time scheduled for receiving the beacon signal, or if the transmitting of the beacon signal implies that the radio entity effectively operates as receiver for transmitting the beacon signal, then the radio entity may configure corresponding symbols as uplink, downlink, or flexible symbols. This may imply that the radio entity acts as receiver over the full frequency band for the first time resource. In particular, this may imply that the first time resource at which the radio entity receives the beacon signal is effectively configured as non-SBFD and/or as a TDD time resource.

Embodiment 19: The method (400) according to any one of the embodiments 13 to 18, wherein the method (400) comprises receiving a message specifying if the receiving of the beacon signal (503) should be performed and/or if the receiving of the beacon signal (503) should be suppressed.

More specifically, the method may comprise receiving a message (or receiving a configuration) specifying whether the first resource should be conditionally reinterpreted, or whether an original configuration should be maintained.

As in the first method aspect, the message (or configuration) may act to override the method, and the message may be a configuration message which the radio entity may receive from another entity in the communication network.

Furthermore, as in the previous method aspect, the message may be received via at least one of radio resource control, RRC, or a system information block, SIB.

Embodiment 20: A radio entity (100, 200), which is configured to operate in a frequency band, wherein the frequency band comprises a frequency subband for which the radio entity (100, 200) is switchable between operating as transmitter and operating as receiver,
the radio entity (100, 200) comprising:
a proximity condition detection module, configured to detect a proximity condition based on a first time, which is a time for transmitting or for receiving the beacon signal (503), and a second time, which is a time for operating as transmitter or receiver, respectively, that is nearest to the first time; and
a transmission or reception module, configured to receive or transmit, respectively, the beacon signal (503) in the frequency subband if the proximity condition is satisfied.

The radio entity may thus be configured to perform the method according to embodiment 1, and/or the method according to embodiment 13.

Embodiment 21: The radio entity (100, 200) according to embodiment 20, wherein the radio entity (100, 200) is configured to perform one or more of the following:
the method (300) according to any one of the embodiments 1 to 12,
the method (400) according to any one of the embodiments 2 to 19.

Embodiment 22: The radio entity (100, 200) according to any one of the embodiments 20 or 21, wherein the radio is a network node or a radio device (100).

The radio entity may thus e.g. be a new generation node B (gNB), or a user equipment (UE), like e.g. a cellular phone, a tablet, or the like.

Embodiment 23: A communication network, comprising the radio entity (100, 200) according to any one of the embodiments 20 to 22.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

1. A method for transmitting a beacon signal, wherein the method is performed by a radio entity which is configured to operate in a frequency band, wherein the frequency band comprises a frequency subband for which the radio entity is switchable between operating as transmitter and operating as receiver, the method comprising:
determining whether a first time, which is a time for transmitting the beacon signal, and a second time, which is a time for operating as transmitter nearest to the first time, satisfy a proximity condition; and
upon determining that the first time and the second time satisfy the proximity condition, transmitting the beacon signal in the frequency subband.

2. The method of claim 1, wherein the proximity condition is based on a temporal proximity of the first time and the second time.

3. The method of claim 1, wherein the proximity condition is a condition that a temporal distance between the first time and the second time is less than a fixed threshold.

4. The method of claim 1, wherein the radio entity is scheduled or configured to operate as a receiver at the first time, and such configuration is disregarded or overridden to transmit the beacon signal in the frequency subband upon determining that the first time and the second time satisfy the proximity condition.

5. The method of claim 1, wherein the radio entity is part of a telecommunications network.

6. The method of claim 5, wherein the radio entity is a network node of a radio access network of the telecommunications network.

7. The method of claim 5, wherein the radio entity is a user equipment of a radio access network of the telecommunications network.

8. The method of claim 5, wherein the beacon signal is a synchronization signal/physical broadcast channel block, SSB.

9. The method of claim 1, wherein the frequency subband is one of a plurality of frequency subbands comprised in the frequency band, and the radio entity is switchable between operating as transmitter and operating as receiver in each of the plurality of subbands.

10. The method of claim 9, wherein the radio entity is configured for subband full duplex, SBFD, operation, and the first time corresponds to a SBFD resource in which the radio entity is configured to operate as a receiver in a first subset of the plurality of frequency subbands including the frequency subband and to operate as a transmitter in a second subset of the plurality of frequency subbands, wherein the first and second subsets are disjoint subsets of the plurality of frequency subbands.

11. The method of claim 10, further comprising, in order to enable the transmitting of the beacon signal at the first time instant, overriding an SBFD configuration for the SBFD resource such that the radio entity interprets the SBFD resource as a non-SBFD resource.

12. The method of claim 1, wherein the beacon signal is, or comprises, a synchronization signal and/or a configuration signal.

13. The method of claim 1, wherein the frequency subband comprises one or more frequency subcarriers and/or one or more physical resource blocks.

14. The method of claim 1, further comprising:
detecting a time of a switch between operating as transmitter and operating as receiver, wherein the time of the switch is between the first time and the second time, and
shifting the time of the switch, such that the switch does not occur between the first time and the second time.

15. The method of claim 1, further comprising, upon determining that the first time and the second time to not satisfy the proximity condition, transmitting the beacon signal in at least one frequency subband which is disjoint from the frequency subband but not in the frequency subband.

16. The method of claim 1, wherein transmission and reception of signals takes place in time resources, the first time marks a first time resource for which the radio entity is configured to operate as a receiver but for which the radio entity is also configured for transmission of the beacon signal, the second time marks a second time resource configured for transmission in the frequency subband, and the proximity condition comprises a condition that the first time resource is adjacent, in time, to the second time resource.

17. The method of claim 16, further comprising, upon determining that the first time and the second time satisfy the proximity condition, reinterpreting the first time resource as a time resource for which the radio entity is configured to operate as a transmitter.

18. The method of claim 16, wherein the first time resource and/or the second time resource is one or more of the following:
a slot,
a half-slot or subslot,
one or more consecutive symbols,
in case of the first time resource, all symbols in a slot at and/or after which no SSB symbols appear,
in case of the first time resource, all symbols in a slot at and/or before which no SSB symbols appear.

19. The method of claim 16, wherein the proximity condition comprises a condition that there is a further time resource where the radio entity is configured to operate as transmitter in the frequency subband such that the first time resource is immediately in-between the second time resource and the further time resource.

20. A method for receiving a beacon signal, wherein the method is performed by a radio entity which is configured to operate in a frequency band, wherein the frequency band comprises a frequency subband for which the radio entity is switchable between operating as transmitter and operating as receiver, the method comprising:
determining whether a first time, which is a time for receiving the beacon signal, and a second time, which is a time nearest to the first time for operating as receiver, satisfy a proximity condition; and
upon determining that the first time and the second time satisfy the proximity condition, receiving the beacon signal in the frequency subband.

21. A radio entity for transmitting a beacon signal, wherein the radio entity is configured to operate in a frequency band and the frequency band comprises a frequency subband for which the radio entity is switchable between operating as transmitter and operating as receiver, the radio entity comprising:
one or more processors; and
memory comprising instructions executable by the one or more processors whereby the radio entity is caused to:
determine whether a first time, which is a time for transmitting the beacon signal, and a second time, which is a time for operating as transmitter nearest to the first time, satisfy a proximity condition; and
upon determining that the first time and the second time satisfy the proximity condition, transmit the beacon signal in the frequency subband.

22. A radio entity for receiving a beacon signal, wherein the radio entity is configured to operate in a frequency band and the frequency band comprises a frequency subband for which the radio entity is switchable between operating as transmitter and operating as receiver, the radio entity comprising:
one or more processors; and
memory comprising instructions executable by the one or more processors whereby the radio entity is caused to:
determining whether a first time, which is a time for receiving the beacon signal, and a second time, which is a time nearest to the first time for operating as receiver, satisfy a proximity condition; and
upon determining that the first time and the second time satisfy the proximity condition, receiving the beacon signal in the frequency subband.
